(19) United States
(12) Patent Application Publication
(10) Pub. No.: US 2025/0223179 A1
(43) Pub. Date: Jul. 10, 2025

(54) METHODS OF MAKING HIERARCHICALLY ORDERED CRYSTALLINE MATERIALS

(71) Applicants: Saudi Arabian Oil Company, Dhahran (SA); King Abdullah University of Science and Technology, Thuwal (SA)

(72) Inventors: Robert Peter Hodgkins, Dhahran (SA); Omer Refa Koseoglu, Dhahran (SA); Rajesh Kumar Parsapur, Thuwal (SA); Anissa Bendjeriou-Sedjerari, Thuwal (SA); Kuo-Wei Huang, Thuwal (SA); Magnus Rueping, Thuwal (SA)

(73) Assignees: Saudi Arabian Oil Company, Dhahran (SA); King Abdullah University of Science and Technology, Dhahran (SA)

(21) Appl. No.: 18/649,176

(22) Filed: Apr. 29, 2024

Related U.S. Application Data
(60) Provisional application No. 63/619,431, filed on Jan. 10, 2024.

(51) Int. Cl. C01B 39/04

(52) U.S. Cl. CPC C01B 39/04; C01P 2006/17

(57) ABSTRACT

Methods of making hierarchically ordered crystalline microporous materials are provided. The method may include forming an aqueous suspension comprising a parent crystalline microporous material, an alkaline reagent, a supramolecular template, and a silica source material, an alumina source material, or both. The method may further include hydrothermally treating the aqueous suspension to form the hierarchically ordered crystalline microporous material. The hierarchically ordered crystalline material may have a greater degree of mesoporosity than the parent crystalline microporous material and may have a silica-to-alumina ratio (SAR) that is at least 0.5 different than the parent crystalline microporous material.

### CROSS-REFERENCE TO RELATED APPLICATIONS

This application claims the benefit of U.S. Provisional Application Ser. No. 63/619,431 filed Jan. 10, 2024, the contents of which are incorporated in their entirety herein.

### FIELD OF THE DISCLOSURE

The present disclosure relates to crystalline materials and, more specifically, to methods for synthesis of crystalline materials such as zeolites.

### BACKGROUND OF THE DISCLOSURE

Materials that include pores, such as zeolites, may be utilized in many petrochemical industrial applications. For instance, such materials may be utilized as catalysts in a number of reactions that convert hydrocarbons or other reactants from feed chemicals to product chemicals. Zeolites may be characterized by a microporous structure framework type. Various types of zeolites have been identified over the past several decades, where zeolite types are generally described by framework types, and where specific zeolitic materials may be more specifically identified by various names such as Zeolite-Y.

### SUMMARY OF THE DISCLOSURE

Some crystalline materials, such as zeolites, may have uniform micropore sizes of up to about 20 angstroms (Å). While zeolites have found utility in their ability to select between small molecules and different cations, mesoporous solids (i.e., those having pores between about 20 Å and 500 Å) may provide further functionality by interacting with larger species. However, such species may not readily diffuse through the microporous zeolite network. Hierarchically ordered crystalline materials, such as hierarchically ordered zeolites (HOZs), which include at least two degrees of porosity (having both micropores and mesopores) may improve diffusion of larger guest species to the active sites of the crystalline materials. Conventional methods of forming hierarchically ordered crystalline materials may result in the long-range ordering of the mesophase in the resulting material to be limited or non-existent and/or the mesopores can be random in size, location and ordering. Further, post-synthetic modification strategies may typically lack control over the silica-to-alumina ratio (SAR) of the HOZs beyond selecting a parent zeolite with an initial SAR, and typically lack control over the dissolution and self-assembly process, resulting in poorly interconnected mesopores.

Accordingly, there is an ongoing need for methods of making hierarchically ordered crystalline materials with a greater selectivity of the SAR and improved mesoporosity. Methods of making hierarchically ordered crystalline materials are provided. Synthesized hierarchically ordered crystalline materials formed according to the methods herein may have improved control of the SAR and may have improved mesoporosity. The methods may include forming an aqueous suspension that includes a parent crystalline microporous material, an alkaline reagent, a supramolecular template, and a silica source material, an alumina source material, or both. The methods may further include hydrothermally treating the aqueous suspension to form the hierarchically ordered crystalline material. The inclusion of the alkaline reagent and the supramolecular template in the method may induce dissolution of the parent crystalline microporous material and self-assembly to produce the hierarchically ordered crystalline material. Further, the inclusion of the silica source material, the alumina source material, or both may tune the SAR of the hierarchically ordered crystalline material.

According to embodiments herein, a method of making a hierarchically ordered crystalline microporous material comprises (A) forming an aqueous suspension comprising a parent crystalline microporous material, an alkaline reagent, a supramolecular template, and a silica source material, an alumina source material, or both; and (B) hydrothermally treating the aqueous suspension to form the hierarchically ordered crystalline microporous material, wherein the hierarchically ordered crystalline microporous material has a greater degree of mesoporosity than the parent crystalline microporous material, and wherein the hierarchically ordered crystalline microporous material has an SAR that is at least 0.5 different than the parent crystalline microporous material.

### BRIEF DESCRIPTION OF THE DRAWINGS

The following detailed description of the present disclosure may be better understood when read in conjunction with the following drawings in which:

FIG. 1 is a schematic overview of hierarchical ordering according to embodiments described herein;

FIG. 2 is a schematic overview of hierarchical ordering according to embodiments described herein;

FIG. 3A depicts low-angle XRD patterns of materials according to embodiments described herein;

FIG. 3B depicts high-angle XRD patterns of materials according to embodiments described herein;

FIG. 4A depicts N₂ physisorption isotherms of materials according to embodiments described herein;

FIG. 4B depicts NLDFT pore-size distributions of materials according to embodiments described herein;

FIG. 5A is a transmission electron microscopy micrograph of hierarchically ordered zeolites according to embodiments described herein;

FIG. 5B is transmission electron microscopy micrographs of hierarchically ordered zeolites according to embodiments described herein;

FIG. 5C is a transmission electron microscopy micrograph of hierarchically ordered zeolites according to embodiments described herein;

FIG. 6A depicts low-angle XRD patterns of materials according to embodiments described herein;

FIG. 6B depicts high-angle XRD patterns of materials according to embodiments described herein;

FIG. 7A depicts N₂ physisorption isotherms of materials according to embodiments described herein;

FIG. 7B depicts NLDFT pore-size distributions of materials according to embodiments described herein;

FIG. 8A is a transmission electron microscopy micrograph of hierarchically ordered zeolites according to embodiments described herein;

FIG. 8B is transmission electron microscopy micrographs of hierarchically ordered zeolites according to embodiments described herein;

FIG. 8C depicts a unit cell schematic and dimensions of a parent zeolite according to embodiments described herein;

FIG. 9A depicts low-angle XRD patterns of materials according to embodiments described herein;

FIG. 9B depicts high-angle XRD patterns of materials according to embodiments described herein;

FIG. 10A is a transmission electron microscopy micrograph of hierarchically ordered zeolite according to embodiments described herein;

FIG. 10B is a transmission electron microscopy micrograph of hierarchically ordered zeolite according to embodiments described herein;

FIG. 10C a transmission electron microscopy micrograph of hierarchically ordered zeolite according to embodiments described herein;

FIG. 11A depicts low-angle XRD patterns of materials according to embodiments described herein;

FIG. 11B depicts high-angle XRD patterns of materials according to embodiments described herein;

FIG. 12A depicts N₂ physisorption isotherms of materials according to embodiments described herein;

FIG. 12B depicts NLDFT pore-size distributions of materials according to embodiments described herein.

Reference will now be made in greater detail to various aspects, some of which are illustrated in the accompanying drawings.

### DETAILED DESCRIPTION

Described herein are methods for making hierarchically ordered crystalline microporous material. In some instances, hierarchically ordered zeolites are discussed herein, which are a type of hierarchically ordered crystalline microporous material. However, it should be understood that the concepts described in the context of zeolites may be applicable to non-zeolitic crystalline materials such as zeolite-type materials such as aluminophosphates (AlPO), silica substituted aluminophosphates (SAPO), or metal comprising aluminophospates (MAPO).

Hierarchically ordered zeolites (HOZs) possessing an ordered mesoporous structure and zeolitized mesopore walls are of great technological importance due to their exceptional properties. HOZs contain different layers of porosity, that is, mesopores (20 and 500 Å) and micropores (less than 20 Å). HOZs offer advantages over traditional microporous zeolites by, for example, improving diffusion of guest species to the active sites, overcoming steric limitations, improving product selectivity, decreasing coke formation, improving hydrothermal stability, and improving accessibility of Brønsted acid sites and Lewis acid sites; and concomitantly, improved catalytic performance.

An attractive property of ordered structures is that their architecture may be described in relation to their symmetry. The regular form of crystals is associated with the regular arrangements of the sub-units comprising the crystal, and hence, the symmetry of the crystal is connected to the symmetry of the sub-units. For example, seven distinct three-dimensional crystal units are provided in Table 1. The crystal systems can be sub-divided upon the symmetry elements present, collectively referred to as the point group and provided in Table 2. For example, 3m infers that a mirror plane having a three-fold axis is present. For the class 3/m (or 6) the mirror plane is perpendicular to the three-fold axis. In 2D space, such as a lamellar system, having fewer dimensions than 3D, there are four crystal systems: hexagonal, square, rectangular and oblique.

Methods of making hierarchically ordered zeolites and zeolite-type materials (hereinafter “crystalline microporous material” or “CMM,” used in singular or plural forms as appropriate) are provided.

Synthesized hierarchically ordered crystalline microporous materials (“HOCMM” used in singular or plural forms as appropriate) formed according to the methods herein may have a greater degree of mesoporosity than a parent CMM formed therefrom. As used herein, the term “degree of mesoporosity” refers to the volume of mesopores present compared to the total pore volume, which may also be referred to as the mesopore volume percent (vol. %). That is, the hierarchically ordered crystalline microporous material may have a greater mesopore vol. % than a parent CMM formed therefrom. The degree of mesoporosity may be quantified by determining the mesopore vol. % using t-plot analysis to determine the micropore volume and subtracting the micropore volume from the total volume.

The hierarchically ordered crystalline microporous materials formed according to the methods herein may have a silica-to-alumina ratio (SAR) that is at least 0.5 different than the parent CMM. As used herein, the SAR refers to the number of moles of silica to moles of alumina, unless stated otherwise. The SAR of the hierarchically ordered crystalline microporous material and the parent CMM may be determined, for example, using inductively coupled plasma mass spectrometry (ICP-MS).

Synthesizing HOCMMs in the process herein may overcome problems associated with known methods by using base-mediated reassembly that includes a supramolecular template and a silica source material, an alumina source material, or both.

In embodiments, the parent CMM may be dissolved to a level of structural building units that are oligomers of the parent CMM. The CMM dissolution and self-assembly may be comprehensively controlled to produce HOCMMs according to the methods herein.

According to embodiments, the method may include forming an aqueous suspension comprising a parent CMM, an alkaline reagent, a supramolecular template, and a silica source material, an alumina source material, or both. The aqueous suspension may be hydrothermally treated to form the hierarchically ordered crystalline microporous material. The hierarchically ordered crystalline microporous material may have a greater degree of mesoporosity than the parent CMM. The hierarchically ordered crystalline microporous material may have an SAR that is at least 0.5 different than the parent CMM.

In embodiments, the aqueous suspension may include an ionic co-solute as an additional anion that is separate from an anion which is paired with a cation of the supramolecular template.

The hydrothermal treatment may maintain the aqueous suspension under conditions to induce incision of the parent CMM into oligomeric units of the CMM, with only a minor portion of monomeric units, and to induce hierarchical reassembly of the oligomeric units into hierarchically ordered crystalline microporous materials. System conditions (including temperature and time of crystallization), selection and concentration of the supramolecular template, and selection and concentration of the alkaline reagent may be tailored to control incision of the parent CMM into oligomeric units and to control reassembly of those oligomeric units around the shape(s) of micelles formed from the supramolecular template. Dissolution of the parent CMM may be encouraged to the extent of oligomer formation while minimizing monomer formation, which may be controlled by selection of the supramolecular template, the alkaline reagent, the optional ionic co-solute and the hydrothermal conditions (including temperature and time). In embodiments, a substantial portion, a significant portion or a major portion of the parent CMM may be cleaved into oligomeric units, with any remainder in the form of monomeric units or atomic constituents of the parent CMM. In embodiments, dimensions of the oligomeric units may correspond approximately to the wall thickness of the hierarchically ordered crystalline microporous material. In embodiments, an interface curvature(s) of the micelles and oligomeric units under reassembly may be tuned to a desired mesostructure and mesoporosity with the aid of an optional ionic co-solute and the Hofmeister effect.

By hydrothermally treating the aqueous suspension, hierarchical ordering by post-synthetic ensembles may occur. The parent CMM may be incised into oligomeric CMM units that rearrange around the shaped micelles formed by the supramolecular template. Hierarchically ordered CMMs may be formed by the supramolecular templating method. In embodiments, the supramolecular template may include those having one or more properties forming a dimension that blocks all, a substantial portion, a significant portion or a major portion of the supramolecular template from entering pores, channels and/or cavities of the parent CMM. These methods disclosed herein may effectuate base-mediated incisions of the CMM crystals in the presence of the supramolecular template of the type/characteristic disclosed herein, into oligomeric components, followed by subsequent reorganization around well-defined micelles by supramolecular templating. This method may produce hierarchically ordered structures having a well-defined long-range mesoporous ordering.

Numerous synthetic strategies to produce hierarchical zeolites fall under two general categories: bottom-up approaches which include the use of hard templates and soft templates, and top-down approaches which typically involve post-synthetic treatment. Bottom-up strategies generally involve templating techniques used in situ during zeolite crystallization, for example using hard templates (carbon sources) or soft templates (surfactants). Top-down strategies generally involve post-synthetic modifications of already formed zeolite crystals, for example, by steaming, dealumination (using an acid) or desilication (using a base). Weaknesses of known processes to produce hierarchically ordered zeolites is that the long-rage ordering of the mesophase in the resulting zeolite is limited or non-existent, mesopores can be random in size, location and ordering. Further, such post-synthetic modification strategies also typically lack control over the SAR beyond selecting a SAR of the parent zeolite. Base-mediated desilication offers a direct route to creating mesoporosity in high-silica frameworks obtained from steaming. In particular, integrating organic templates during the desilication process may significantly improve crystallinity and mesoporosity. However, conventional post-synthetic modification strategies typically lack control over the dissolution and self-assembly process, resulting in poorly interconnected mesopores. The methods described herein may provide control over the dissolution and self-assembly process to overcome limitations of such conventional methods.

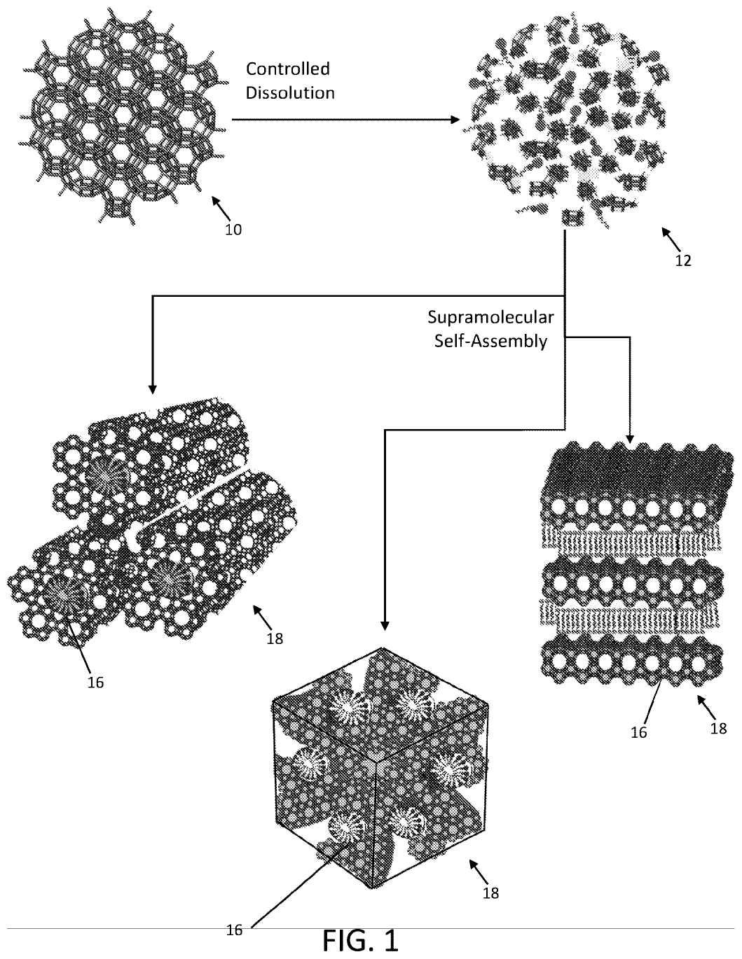

The curvature or shape of the micelles may affect a mesophase symmetry of the hierarchically ordered crystalline microporous material, for example, hexagonal, cubic or lamellar. Formation of the supramolecular template molecules into micelles may be dependent upon factors such as the supramolecular template type, supramolecular template concentration, presence or absence of an ionic co-solute, CMM type(s), crystallization temperature, type of alkaline reagent, concentration of alkaline reagent, pH level of the system, and/or presence or absence of other reagents. In general, at low concentrations supramolecular templates exist as discrete entities. At higher concentrations, that is, above a critical micelle concentration (CMC), micelles are formed. The hydrophobic interactions in the system including the supramolecular template alters the packing shape of the supramolecular templates into, for example, spherical, prolate or cylindrical micelles, which can thereafter form thermodynamically stable two-dimensional or three-dimensional liquid crystalline phases of ordered mesostructures (see, for example, FIG. 1.4 of Zana, R. (Ed.). (2005). Dynamics of Surfactant Self-Assemblies: Micelles, Microemulsions, Vesicles and Lyotropic Phases (1st ed.). CRC Press, Chapter 1, which shows self-assembly based on surfactant and surfactant packing parameter).

In embodiments, the Hofmeister series (HS), ion specific effect, or lyotropic sequence is followed for selection of supramolecular templates and/or ionic co-solute to control curvature or shape (e.g., spherical, ellipsoid, cylindrical, or unilamellar structures) of the micelles (see, for example, Beibei Kang, Huicheng Tang, Zengdian Zhao, and Shasha Song. “Hofmeister Series: Insights of Ion Specificity from Amphiphilic Assembly and Interface Property” ACS Omega 5 (2020): 6229-6239). In embodiments of the methods of making hierarchically ordered crystalline microporous material disclosed herein, mesophase transitions of hierarchical ensembles may yield distinct mesostructures based on the anionic Hofmeister effect and supramolecular self-assembly. Anions of different sizes and charges possess different polarizabilities, charge densities and hydration energies in aqueous solutions. When paired with a positive supramolecular template head group, these properties can affect the short-range electrostatic repulsions among the head groups and hydration at the micellar interface, thus changing the area of the head group (α₀). Such ion-specific interactions can be a driving force in changing the micellar curvature and inducing mesophase transition. Based on the HS(SO₄⁻>HPO₄⁻>OAc⁻>Cl⁻>Br⁻>NO₃⁻>ClO₄⁻>SCN⁻), strongly hydrated ions (left side of the HS) can increase the micellar curvature, whereas weakly hydrated ions can decrease the micellar curvature. A surfactant packing parameter, g=V/α₀l (V=total volume of surfactant tails, α₀=area of the head group, l=length of surfactant tail), can be used to describe these mesophase transitions.

In embodiments, the alkaline reagent may include one or more basic compounds to maintain the system at a pH level of greater than about 8. In embodiments, the alkaline reagent may be provided at a concentration in the aqueous suspension of about 0.1-2.0 M. In embodiments, the alkaline reagent may be provided at a concentration in the aqueous suspension of about 0.1-5 wt %. In embodiments, the alkaline reagent may comprise urea. In embodiments, the alkaline reagent may comprise ammonia. In embodiments, the alkaline reagent may comprise ammonium hydroxide. In embodiments, the alkaline reagent may comprise sodium hydroxide. In embodiments, the alkaline reagent may comprise alkali metal hydroxides including hydroxides of sodium, lithium, potassium, rubidium, or cesium.

In embodiments, the alkaline reagent may be effective to enable controlled hydrolysis; for example, urea can be used as an alkaline agent, and during hydrolysis urea reacts to form ammonium hydroxide. In such embodiments, pH may be increased relatively slowly to a maximum pH as a function of time, which is beneficial to the process, rather than adding an amount of another alkaline reagent such as ammonium hydroxide in the initial solution to the maximum pH.

In embodiments, the rate and extent of CMM dissolution may be controlled by employing urea as an in situ base, and by mediating hydrothermal temperature to control urea hydrolysis and fine-tune pH of the solution; extent of dissolution into smaller oligomers may be controlled by the surfactant-CMM interactions during the initial stages of dissolution, whereby influence of the ion-specific interactions, that is, anionic Hofmeister effect (AHE) on supramolecular self-assembly directs formation of hierarchically ordered structures with hexagonal mesopore symmetry, bicontinuous gyroid cubic mesopore symmetry and lamellar symmetry; In embodiments, the hierarchically ordered structures may possess hexagonal P6 mm mesopore symmetry, bicontinuous gyroid cubic Ia-3d mesopore symmetry, or lamellar p2 symmetry.

In embodiments the alkaline reagent may comprise alkylammonium cations, having the general formula RₓH₄₋ₓN⁺[A⁻], wherein X=1-4, R1, R2, R3 and R4 can be the same or different C1-C30 alkyl groups, and wherein [A⁻] is a counter anion such as OH⁻, Br⁻, Cl⁻ or I⁻. In embodiments, the alkaline reagent may comprise quaternary ammonium cations with alkoxysilyl groups, phosphonium groups, an alkyl group, or an alkoxyl group. In embodiments, the alkylammonium cations used in this regard may function as a base rather than as a surfactant or template.

In embodiments using ammonia, ammonium hydroxide or alkali metal hydroxides, an amorphous material may also be present with the crystalline material in the product. In embodiments, upon calcining the as-made hierarchically ordered crystalline microporous material, there may be a reduction in the amount of apparent amorphous material present (for example an overall broad band at 25° (28) in XRD), indicative of apparent “self-healing” after calcination. In embodiments, by the controlled hydrolysis of urea to ammonium hydroxide there may be a reduction in the amount of apparent amorphous material present in the hierarchically ordered crystalline microporous material (for example an overall broad band at 25° (28) in XRD), when compared with alternative routes such as NaOH or directly with ammonium hydroxide.

In embodiments, the supramolecular template used in the methods described herein may assist the reassembly and recrystallization of dissolved components (oligomers) by covalent and/or electrovalent interactions. In embodiments, the supramolecular template comprises a surfactant. The supramolecular template may be provided at a concentration in the aqueous suspension of about 0.01-0.5 M. In embodiments, the supramolecular template may be provided at a concentration in the aqueous suspension of about 0.5-10 wt %, such as from 1 wt % to 9 wt. %, from 2 wt % to 8 wt %, from 3 wt % to 7 wt %, from 4 wt % to 6 wt. %, or any and all ranges and sub-ranges between the foregoing values, based on the total weight of the aqueous suspension. The supramolecular template may have constrained diffusion within the micropore channels of parent CMM, referred to as bulky surfactants or bulky supramolecular templates. Diffusion of molecules of the supramolecular template into micropore-channels or cavities encourages CMM dissolution. This effect may be minimized in the top-down methods of making the hierarchically ordered crystalline microporous material disclosed herein, wherein the supramolecular template minimize diffusion or partial diffusion thereof into CMM pore-channels, cavities or window openings. Such supramolecular templates possess suitable dimensions to block such diffusion. The suitable dimensions can be a based on dimensions of a head group and/or a tail group of a supramolecular template. In embodiments, suitable dimensions can be based on a co-template having one or more components with suitable head and/or tail groups, or being a template system arranged in such a way, so as to minimize or block diffusion in to CMM pore-channels, cavities or window openings. By minimizing diffusion of templates into the CMM pore channels, CMM dissolution into oligomers and comprehensive reorganization and assembly into the hierarchically ordered crystalline microporous material disclosed herein is encouraged. In embodiments, at least a substantial portion, a significant portion or a major portion of the supramolecular template may not enter into pores and/or channels of the CMM. For example, organosilanes (˜0.7 nm) are relatively large compared with quaternary ammonium surfactants without such bulky groups including cetyltrimethylammonium bromide (CTAB) (˜0.25 nm). In embodiments, a supramolecular template may contain a long chain linear group (>˜0.6 nm). In embodiments, a supramolecular template may contain an aromatic or aromatic derivative group (>˜0.6 nm). In embodiments, the supramolecular template may contain one or more bulky groups having a dimension based on modeling of molecular dimensions as a cuboid having dimensions A, B and C, using Van der Waals radii for individual atoms, wherein one or more, two or more, or all three of the dimensions A, B and C are sufficiently close in dimension, or sufficiently larger in dimension, that constrains diffusion into the micropores of the selected parent CMM. As used herein, “sufficiently close” may refer to a difference of 20% or less. As used herein, “sufficiently larger” may refer to greater than 20%.

In embodiments, the supramolecular template may contain at least one moiety, as a head group or a tail group, chosen from organosilanes, hydroxysilyls, alkoxysilyls, aromatics, branched alkyls, sulfonates, carboxylates, phosphates and combinations comprising one of the foregoing moieties. In embodiments, the supramolecular template may be an organosilane that comprises at least one hydroxysilyl as a head group moiety. In embodiments, the supramolecular template may be an organosilane that comprises at least one hydroxysilyl as a tail group moiety. In embodiments, the supramolecular template may be an organosilane that comprises at least one alkoxysilyl as a head group moiety. In embodiments, the supramolecular template may be an organosilane that comprises at least one alkoxysilyl as a tail group moiety. In embodiments, the supramolecular template may comprise at least one aromatic as a head group moiety. In embodiments, the supramolecular template may comprise at least one aromatic as a tail group moiety. In embodiments, the supramolecular template may comprise at least one branched alkyl as a head group moiety. In embodiments, the supramolecular template may comprise at least one branched alkyl as a tail group moiety. In embodiments, the supramolecular template may comprise at least one sulfonate as a head group moiety. In embodiments, the supramolecular template may comprise at least one sulfonate as a tail group moiety. In embodiments, the supramolecular template may comprise at least one carboxylate as a head group moiety. In embodiments, the supramolecular template may comprise at least one carboxylate as a tail group moiety. In embodiments, the supramolecular template may comprise at least one phosphate as a head group moiety. In embodiments, the supramolecular template may comprise at least one phosphate as a tail group moiety. These moieties may have one or more dimensions that constrain diffusion into pores of a parent CMM. In embodiments, in which the CMM is characterized by pores of various dimensions, the selected moieties may be characterized by one or more dimensions that constrain diffusion into the largest pores of the parent CMM.

In embodiments the supramolecular template may comprise at least one cationic moiety. In embodiments, the supramolecular template may comprise at least one cationic moiety chosen from a quaternary ammonium moiety and a phosphonium moiety. In embodiments, the supramolecular template may comprise at least one quaternary ammonium group having a terminal alkyl group with 6-24 carbon atoms. In embodiments, the supramolecular template may comprise two quaternary ammonium groups wherein an alkyl group bridging the quaternary ammonium groups comprises 1-10 carbon atoms. In embodiments, the supramolecular template may comprise at least one quaternary ammonium group, and at least one constituent group, a head group moiety as described above. In embodiments, the supramolecular template may comprise at least one quaternary ammonium group, and at least one constituent group, a tail group moiety as described above. In embodiments, the supramolecular template may comprise at least one quaternary ammonium group, at least one constituent group, a head group moiety as described above, and an alkyl group that comprises 1-10 carbon atoms bridging at least one of the quaternary ammonium groups and at least one of the head groups. In embodiments, the supramolecular template may comprise at least one quaternary ammonium group, at least one constituent group, a tail group moiety as described above, and an alkyl group that comprises 1-10 carbon atoms bridging at least one of the quaternary ammonium groups and at least one of the tail groups.

In embodiments the supramolecular template may comprise a quaternary ammonium compound and a constituent group comprising one or more bulky organosilane or alkoxysilyl substituents. In embodiments, the supramolecular template may comprise a quaternary ammonium compound and a constituent group comprising one or more long-chain organosilane or alkoxysilyl substituents. In embodiments, the supramolecular template may comprise dimethyloctadecyl (3-trimethoxysilyl-propyl)-ammonium or derivatives of dimethyloctadecyl (3-trimethoxysilyl-propyl)-ammonium. In embodiments, the supramolecular template may comprise dimethylhexadecyl (3-trimethoxysilyl-propyl)-ammonium or derivatives of dimethylhexadecyl (3-trimethoxysilyl-propyl)-ammonium. In embodiments, the supramolecular template may comprise a double-acyloxy amphiphilic organosilane such as [2,3-bis(dodecanoyloxy)-propyl](3-(trimethoxysilyl) propyl)-dimethylammonium or derivatives of [2,3-bis(dodecanoyloxy)-propyl](3-(trimethoxysilyl) propyl)-dimethylammonium.

In embodiments, the supramolecular template may comprise a quaternary phosphonium compound and a constituent group comprising one or more bulky aromatic substituents. In embodiments, the supramolecular template may comprise a quaternary phosphonium compound and a constituent group comprising one or more bulky alkoxysilyl or organosilane substituents.

In embodiments the supramolecular template may comprise a tail group moiety chosen from aromatic groups comprising 6-50, 6-25, 10-50 or 10-25 carbon atoms, alkyl groups comprising 1-50, 1-25, 5-50, 5-25, 10-50 or 10-25 carbon atoms, aryl groups comprising 1-50, 1-25, 5-50, 5-25, 10-50 or 10-25 carbon atoms, or a combination of aromatic and alkyl groups having up to 50 carbon atoms. In embodiments, the supramolecular template may comprise a head group moiety chosen from aromatic groups comprising 6-50, 6-25, 10-50 or 10-25 carbon atoms, alkyl groups comprising 1-50, 1-25, 5-50, 5-25, 10-50 or 10-25 carbon atoms, aryl groups comprising 1-50, 1-25, 5-50, 5-25, 10-50 or 10-25 carbon atoms, or a combination of aromatic and alkyl groups having up to 50 carbon atoms. In embodiments, the supramolecular template may comprise co-templated agents chosen from quaternary ammonium compounds (including for example quaternary alkyl ammonium cationic species) and quaternary phosphonium compounds.

In embodiments, the supramolecular template may comprise (a) at least one of: aromatic quaternary ammonium compounds, branched alkyl chain quaternary ammonium compounds, alkyl benzene sulfonates, alkyl benzene phosphonates, alkyl benzene carboxylates, or substituted phosphonium cations; and (b1) and a constituent group comprising at least one of organosilanes, hydroxysilyls, alkoxysilyls, aromatics, branched alkyls, sulfonates, carboxylates or phosphates, as a head group; or (b2) and a constituent group comprising at least one of organosilanes, hydroxysilyls, alkoxysilyls, aromatics, branched alkyls, sulfonates, carboxylates or phosphates, as a tail group. In embodiments, the supramolecular template may include a sulfonate group (a non-limiting example is sulfonated bis(2-hydroxy-5-dodecylphenyl) methane (SBHDM)). In embodiments, the supramolecular template may comprise a carboxylate group (a non-limiting example is sodium 4-(octyloxy)benzoate). In embodiments, the supramolecular template may comprise a phosphonate group (a non-limiting example is tetradecyl (1,4-benzene)bisphosphonate). In embodiments, the supramolecular template may comprise an aromatic group (a non-limiting example is benzylcetyldimethylammonium chloride). In embodiments, the supramolecular template may comprise an aliphatic group (a non-limiting example is tetraoctylammonium chloride).

The supramolecular template is provided as a cation/anion pair. In embodiments, a cation of the supramolecular template is as described above and is paired with an anion selected such as Cl, Br, OH, F, or I. In embodiments, a cation of a supramolecular template is as described above and is paired with an anion such as Cl, Br or OH. In embodiments, the supramolecular template may comprise dimethyloctadecyl [3-(trimethoxysilyl) propyl] ammonium chloride (commonly abbreviated as “TPOAC”) or derivatives of dimethyloctadecyl [3-(trimethoxysilyl) propyl] ammonium chloride. In embodiments, the supramolecular template may comprise dimethylhexadecyl [3-(trimethoxysilyl) propyl] ammonium chloride or derivatives of dimethylhexadecyl [3-(trimethoxysilyl) propyl] ammonium chloride. In embodiments, the supramolecular template may comprise [2,3-bis(dodecanoyloxy)-propyl] (3-(trimethoxysilyl) propyl)-dimethylammonium iodide or derivatives of [2,3-bis(dodecanoyloxy)-propyl](3-(trimethoxysilyl) propyl)-dimethylammoniumiodide.

In embodiments, the silica source material, the alumina source material, or both used in the methods described herein may assist in modifying the SAR of the hierarchically ordered crystalline microporous material compared with embodiments that do not include silica source material, the alumina source material, or both.

In embodiments, the aqueous suspension may comprise from 1 wt. % to 30 wt. % of the silica source material, the alumina source material, or both such as from 1 wt. % to 25 wt. %, from 5 wt. % to 20 wt. %, from 10 wt. % to 15 wt. %, or any and all ranges and sub-ranges between the foregoing values, based on the total weight of the aqueous suspension. Without intending to be bound by any particular theory, it is believed that the inclusion of the alumina source material in the aqueous suspension in addition to the parent CMM, the alkaline reagent, the supramolecular template, and optionally the ionic co-solute, may decrease the SAR of the hierarchically ordered crystalline microporous material relative to the SAR of the parent CMM. Further, it is believed that the inclusion of the silica source material in the aqueous suspension in addition to the parent CMM, the alkaline reagent, the supramolecular template, and optionally the ionic co-solute, may increase the SAR of the hierarchically ordered crystalline microporous material relative to the SAR of the parent CMM.

In embodiments, the aqueous suspension may have a weight ratio of the parent CMM to the silica source material, the alumina source material, or both of from 100:1 to 1:1, such as from 50:1 to 1:1, from 25:1 to 1:1, from 10:1 to 1:1, from 50:1 to 5:1, from 25:1 to 5:1, or from 10:1 to 5:1, from 100:1 to 10:1, from 50:1 to 10:1, or from 25:1 to 10:1. The amounts of silica source material, the alumina source material, or both may be selected based on a desired SAR of the hierarchically ordered crystalline microporous material relative to the SAR of the parent CMM.

In embodiments, the aqueous suspension may comprise the alumina source material, and the alumina source material may comprise aluminates, alumina, aluminum colloids, boehmites, pseudo-boehmites, aluminum hydroxides, aluminum salts, aluminum alkoxides, aluminum wire, alumina gels, zeolites, or combinations thereof. In embodiments, the aqueous suspension may comprise the alumina source material, and the alumina source material may be chosen from aluminates, alumina, aluminum colloids, boehmites, pseudo-boehmites, aluminum hydroxides, aluminum salts, aluminum alkoxides, aluminum wire, alumina gels, zeolites, and combinations thereof. In embodiments, the alumina source material may be a different from the parent CMM (that is, the alumina source is in addition to the parent CMM).

In embodiments, the aqueous suspension may comprise the silica source material, and the silica source material may comprise sodium silicate, fumed silica, precipitated silica, colloidal silica, silica gels, zeolites, dealuminated zeolites, rice husk, silicon hydroxides, silicon alkoxides, or combinations thereof. In embodiments, the aqueous suspension may comprise the silica source material, and the silica source material be chosen from sodium silicate, fumed silica, precipitated silica, colloidal silica, silica gels, zeolites, dealuminated zeolites, rice husk, silicon hydroxides, silicon alkoxides, and combinations thereof. In embodiments, the silica source material may be a different from the parent CMM (that is, the silica source is in addition to the parent CMM).

In embodiments, the silica source material, the alumina source material, or both used in the methods described herein may assist in modifying the mesopore distribution in the hierarchically ordered crystalline microporous material compared with embodiments that do not include the silica source material, the alumina source material, or both. The mesopore distribution may be determined using non-local density functional theory (NLDFT) in combination with gas adsorption isotherms. In embodiments that include the silica source material, the alumina source material, or both, the hierarchically ordered crystalline microporous material may have a bimodal mesopore distribution comprising a first peak and a second peak. In embodiments, the first peak may be from 2 nm to 4 nm and the second peak may be from 4 nm to 6 nm. In embodiments, at least 20, 30, 40, 50, 60, or 70% of the mesopores within the mesopore size range from 2 nm to 6 nm may be present within 2 nm to 4 nm, based on the total volume of the mesopores. In embodiments, at least 20, 30, 40, 50, 60, or 70% of the mesopores within the mesopore size range from 2 nm to 6 nm may be present within 4 nm to 6 nm, based on the total volume of the mesopores. That is, the inclusion of the silica source material, the alumina source material, or both in the aqueous suspension may increase the bimodality (i.e. modify the mesopore sizes such that a difference between an amount of mesopores within each of the two separate ranges is less) of mesopore sizes in the hierarchically ordered crystalline microporous materials compared with similar methods in the absence of the silica source material, the alumina source material, or both. Without intending to be bound by any particular theory, it is believed that the increased bimodality may provide two separate mesopore size peaks in the hierarchically ordered crystalline microporous material, which may interact with different sized analytes.

The volume of mesopores present compared with the total pore volume is referred to as the mesopore pore volume percent (vol. %). In embodiments, the hierarchically ordered crystalline microporous material may have a mesopore vol. % that is at least 1%, at least 2%, at least 3%, at least 4%, or at least 5% greater than a similarly formed hierarchically ordered crystalline microporous material that does not include the silica source material, the alumina source material, or both in the aqueous suspension.

In embodiments, the aqueous suspension may include an ionic co-solute (that is, in addition to the anion paired with the supramolecular template). In embodiments in which an ionic co-solute is present, it may be provided at a concentration in the aqueous suspension of less than about 0.5 M, such as about 0.01-0.5 M. In embodiments in which an ionic co-solute is used, it may be provided at a concentration in the aqueous suspension of about 0.01-5 wt %. In embodiments, the ionic co-solute may be chosen from CO₃²⁻, SO₄²⁻, S₂O₃²⁻, H₂PO₄⁻, F⁻, Cl⁻, Br⁻, NO₃⁻, I⁻, ClO₄⁻, SCN⁻ and C₆H₅O₈³⁻. (citrate). In embodiments, an ionic co-solute may be chosen from SO₄²⁻, NO₃⁻, and ClO₄⁻. In embodiments, the ionic co-solute may be selected based on the Hofmeister series/Lyotropic series to control the curvature/shape of the micelles to yield the desired mesophase symmetry, for example, hexagonal, cubic or lamellar. In embodiments, the ionic co-solute may be a nitrate (NO₃⁻) selected based on the Hofmeister series/Lyotropic series to control the curvature/shape of the micelles to yield the hierarchically ordered crystalline microporous material having a cubic mesophase symmetry. In embodiments using nitrate as an ionic co-solute, a nitrate salt may be used, such as ammonium nitrate or a metal nitrate, wherein the metal can be an alkali metal, an alkali earth metal, a transition metal, a noble metal or a rare earth metal. In embodiments, the ionic co-solute may be a sulfate (SO₄⁻) selected based on the Hofmeister series/Lyotropic series to control the curvature/shape of the micelles to yield the hierarchically ordered crystalline microporous material having a hexagonal mesophase symmetry. In embodiments using sulfate as an ionic co-solute, a sulfate salt may be used, such as ammonium sulfate or a metal sulfate, wherein the metal can be an alkali metal, an alkali earth metal, a transition metal, a noble metal or a rare earth metal. In embodiments, the ionic co-solute may be a perchlorate (ClO₄⁻) selected based on the Hofmeister series/Lyotropic series to control the curvature/shape of the micelles to yield the hierarchically ordered crystalline microporous material having a lamellar mesophase symmetry. In embodiments using perchlorate as an ionic co-solute, a sulfate salt may be used, such as sodium perchlorate, or another metal perchlorate, wherein the metal can be an alkali metal, an alkali earth metal, a transition metal, a noble metal or a rare earth metal.

The present disclosure is applicable to various types of CMMs as a parent material, including zeolite or zeolite-type materials. In embodiments, the parent CMM exhibits both good crystallinity and Al-distribution to obtain high-quality hierarchically ordered crystalline microporous materials while minimizing composite phases and/or impurities.

In embodiments, the parent CMM may not be hierarchically ordered, or may be substantially microporous (such as wherein at least 80%, at least 85%, at least 90%, at least 95%, or at least 99% of the pores in the parent CMM are micropores).

Suitable zeolitic materials as a parent CMM include those identified by the International Zeolite Association, including those with the identifiers ABW, ACO, AEI, AEL, AEN, AET, AFG, AFI, AFN, AFO, AFR, AFS, AFT, AFV, AFX, AFY, AHT, ANA, ANO, APC, APD, AST, ASV, ATN, ATO, ATS, ATT, ATV, AVE, AVL, AWO, AWW, BCT, BEC, BIK, BOF, BOG, BOZ, BPH, BRE, BSV, CAN, CAS, CDO, CFI, CGF, CGS, CHA, -CHI, -CLO, CON, CSV, CZP, DAC, DDR, DFO, DFT, DOH, DON, EAB, EDI, EEI, EMT, EON, EPI, ERI, ESV, ETL, ETR, ETV, EUO, EWO, EWS, EZT, FAR, FAU, FER, FRA, GIS, GIU, GME, GON, GOO, HEU, IFO, IFR, -IFT, -IFU, IFW, IFY, IHW, IMF, IRN, IRR, -IRY, ISV, ITE, ITG, ITH, ITR, ITT, -ITV, ITW, IWR, IWS, IWV, IWW, JBW, JNT, JOZ, JRY, JSN, JSR, JST, JSW, KFI, LAU, LEV, LIO, -LIT, LOS, LOV, LTA, LTF, LTJ, LTL, LTN, MAR, MAZ, MEI, MEL, MEP, MER, MFI, MFS, MON, MOR, MOZ, MRT, MSE, MSO, MTF, MTN, MTT, MTW, MVY, MWF, MWW, NAB, NAT, NES, NON, NPO, NPT, NSI, OBW, OFF, OKO, OSI, OSO, OWE, -PAR, PAU, PCR, PHI, PON, POR, POS, PSI, PTO, PTT, PTY, PUN, PWN, PWO, PWW, RHO, -RON, RRO, RSN, RTE, RTH, RUT, RWR, RWY, SAF, SAO, SAS, SAT, SAV, SBE, SBN, SBS, SBT, SEW, SFE, SFF, SFG, SFH, SFN, SFO, SFS, SFW, SGT, SIV, SOD, SOF, SOR, SOS, SOV, SSF, SSY, STF, STI, STT, STW, -SVR, SVV, SWY, -SYT, SZR, TER, THO, TOL, TON, TSC, TUN, UEI, UFI, UOS, UOV, UOZ, USI, UTL, UWY, VET, VFI, VNI, VSV, WEI, -WEN, YFI, YUG, ZON, *BEA, *CTH, *-EWT, *-ITN, *MRE, *PCS, *SFV, *-SSO, *STO, *-SVY and *UOE. For example, certain zeolites known to be useful in the petroleum refining industry include but are not limited to AEI, *BEA, CHA, FAU, MFI, MOR, LTL, LTA or MWW. In embodiments, a parent zeolite can be (FAU) framework zeolite, which includes USY, for example having a micropore size related to the 12-member ring when viewed along the [111] direction of 7.4×7.4 Å. In embodiments, a parent zeolite can be (MFI) framework zeolite, which includes ZSM-5, for example having a micropore size related to the 10-member rings when viewed along the [100] and directions of 5.5×5.1 Å and 5.6×5.3 Å, respectively. In embodiments, a parent zeolite can be (MOR) framework zeolite, which includes mordenite zeolites, for example having a micropore size related to the 12-member ring and 8-member ring when viewed along the [001] and directions of 6.5×7.0 Å and 2.6×5.7 Å, respectively. In embodiments, a parent zeolite can be (*BEA) framework zeolite, which includes zeolite beta polymorph A, for example having a micropore size related to the 12-member rings when viewed along the [100] and [001] directions of 6.6×6.7 Å and 5.6×5.6 Å, respectively. In embodiments, a parent zeolite can be (CHA) framework zeolite, which includes chabazite zeolite, for example having a micropore size related to the 8-member ring when viewed normal to the [001] direction of 3.8×3.8 Å. In embodiments, a parent zeolite can be (LTL) framework zeolite, which includes Linde Type L zeolite (zeolite L), for example having a micropore size related to the 12-member ring when viewed along the [001] direction of 7.1×7.1 Å. In embodiments, a parent zeolite can be (LTA) framework zeolite, which includes Linde Type A zeolite (zeolite A), for example having a micropore size related to the 8-member ring when viewed along the [100] direction of 4.1×4.1 Å. In embodiments, a parent zeolite can be (AEI) framework zeolite, for example having a micropore size related to the 8-member ring when viewed normal to the [001] direction of 3.8×3.8 Å. In embodiments, a parent zeolite can be (MWW) framework zeolite, which includes MCM-22, for example having a micropore size related to the 10-member rings when viewed normal to [001] direction ‘between layers’ and ‘within layers’ of 4.0×5.5 Å and 4.1×5.1 Å, respectively.

In embodiments the parent CMM may be a zeolite-type material, for example, aluminophosphates (AIPO), silicon-substituted aluminophosphates (SAPO), or metal-comprising aluminophosphates (MAPO). In embodiments, the parent CMM may be a zeolitic siliceous only framework material.

As described above, embodiments herein include supramolecular templates that contain one or more bulky groups having a dimension based on modeling of molecular dimensions as a cuboid having dimensions A, B and C, using Van der Waals radii for individual atoms, wherein one or more, two or more, or all three of the dimensions A, B and C are sufficiently close in dimension, or sufficiently larger in dimension, that constrains diffusion into the micropores of the CMM. As used herein, “sufficiently close” may refer to a difference of 20% or less. As used herein, “sufficiently larger” may refer to greater than 20% or greater. Also as described above with respect to the known parameters related to pore dimensions for exemplary zeolites, such parameters may influence the selection of the supramolecular template. For instance, in the examples herein, FAU zeolite is used; when the supramolecular template material was CTAB (˜0.25 nm), hierarchically ordered crystalline microporous materials were not realized; however, when the supramolecular template was an organosilane (˜0.7 nm), hierarchically ordered crystalline microporous materials were realized, as these are closer in dimension to the pore dimensions for FAU zeolite and therefore are constrained from entering such pores. Likewise, suitable supramolecular templates are determined based on a selected parent CMM.

In embodiments, the parent CMMs used in the methods are zeolites herein having a SAR suitable for the particular type of zeolite. In general, the SAR of parent zeolites can be in the range of about 2-10000, 2-5000, 2-500, 2-100, 2-80, 5-10000, 5-5000, 5-500, 5-100, 5-80, 10-10000, 10-5000, 10-500, 10-100, 10-80, 50-10000, 50-5000, 50-1000, 50-500 or 50-100. In embodiments, the SAR of the parent zeolite may be greater than or equal to 5 or 10 to achieve long-range ordering. In embodiments with a SAR of less than 10, uniform mesoporosity and certain degree of ordering is attainable, and amorphous framework material remains in the product.

In embodiments, the hierarchically ordered crystalline microporous material may have a SAR that is at least 0.5, 1.0, 2.0, 5.0, 10.0, 15.0, 20.0, 25.0, 30.0, or 35 different than the parent CMM.

In embodiments, the hierarchically ordered crystalline microporous material may have a SAR that is at least 0.5, 1.0, 2.0, 5.0, 10.0, 15.0, 20.0, 25.0, 30.0, or 35 different than a similarly formed hierarchically ordered crystalline microporous material that did not include the silica source material, the alumina source material, or both.

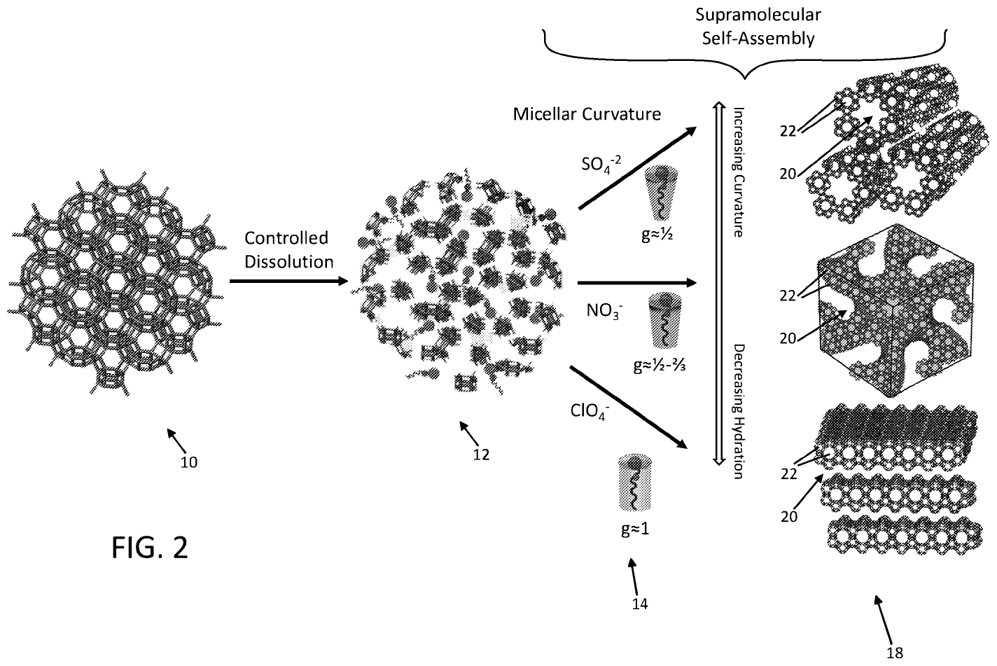

Now referring to FIG. 1 and FIG. 2, both of which provide schematic overviews of the hierarchical ordering by post-synthetic ensembles synthesis route described herein, including the general synthesis mechanism of and how AHE influences g values to alter the micellar curvature and induce mesophase transition. Although the parent CMM schematically depicted in FIG. 1 and FIG. 2 is FAU zeolite, it is appreciated that other CMMs can be utilized as the parent CMM by post-synthetic ensembles synthesis route.

In embodiments, base-mediated dissolution/incision of the parent CMMs into oligomeric components, and reorganization into hierarchically ordered mesostructures by supramolecular templating, and by the Hofmeister effect may occur. The parent CMM 10 is provided in crystalline form. The aqueous suspension is formed comprising the parent CMM 10, an alkaline reagent, a supramolecular template, and a silica source material, an alumina source material, or both. The aqueous suspension may be maintained under hydrothermal conditions to form oligomeric CMM units 12 of the parent CMM 10 (such as oligomeric zeolitic units when the parent CMM is zeolite). The supramolecular template molecules 14 form into shaped micelles 16 (not shown in FIG. 2) and oligomeric CMM units hierarchically reassemble and crystallize around the shaped micelles as an ordered mesostructure, HOCMM 18, having me sopores 20 of defined symmetry and mesopore walls formed of the oligomeric CMM units thereby retaining micropores 22 of the underlying CMM structure of the parent CMM. In embodiments, a composition of matter produced by the method herein is the HOCMM 18 that comprises shaped micelles 16. In embodiments, a composition of matter produced herein is the HOCMM 18 having the supramolecular template molecules 14 formed into shaped micelles 16 removed, for example by: chemical methods such as solvent extraction, chemical oxidation, or ionic liquid treatment; or physical methods such as calcination, supercritical CO₂, microwave-assisted treatment, ultrasonic-assisted treatment, ozone treatment, or plasma technology.

Referring particularly to FIG. 2, the general synthesis mechanism is shown including a schematic representation of how AHE influences g values to alter the micellar curvature and induce mesophase transition. When a sulfate is used as an ionic co-solute, the micellar curvature is represented by a surfactant packing parameter g of about ½, and the resulting HOCMM possesses long-range mesoporous ordering of hexagonal symmetry. When a nitrate is used as an ionic co-solute, the micellar curvature is represented by a surfactant packing parameter g in the range of about ½ to about ⅔ and the resulting HOCMM possesses long-range mesoporous ordering of cubic symmetry. When a perchlorate is used as an ionic co-solute, the micellar curvature is represented by a surfactant packing parameter g the range of about 1, and the resulting HOCMM possesses long-range mesoporous ordering of lamellar symmetry. FIG. 2 also shows the influence of ion-specific interactions (The Hofmeister effect) on the micellar curvature in a self-assembly process. Anions of different sizes and charges possess different polarizabilities, charge densities and hydration energies in aqueous solutions. When paired with a positive surfactant head group, these properties can affect the electrostatic repulsions among the head groups and hydration at the micellar interface, thus changing the area of the head group (ao). Such short-range ion-specific interactions can be a significant driving force in changing the micellar curvature and inducing mesophase transition. Based on the Hofmeister series (SO₄⁻>HPO₄⁻>OAc⁻>Cl⁻>Br⁻>NO₃⁻>ClO₄⁻>SCN⁻), the strongly hydrated ions (left side of series) can increase the micellar curvature, whereas weakly hydrated ions can decrease the micellar curvature.

In embodiments, the aqueous suspension comprises water. In embodiments, the solvent is water. In embodiments, the water may be in the presence of co-solvents chosen from polar solvents, non-polar solvents and pore swelling agents (such as 1,3,5-trimethylbenzene). In embodiments, the solvent may be chosen from polar solvents, non-polar solvents and pore swelling agents (such as 1,3,5-trimethylbenzene), in the absence of water. In embodiments, the mixture components of the aqueous suspension may be added with water to the reaction vessel prior to heating. Typically, water allows for adequate mixing to realize a more homogeneous distribution of the suspension components, which ultimately produces a more desirable product because each crystal is more closely matched in properties to the next crystal. Insufficient mixing could result in undesirable products with respect to amorphous phases or a lesser degree of long-range order.

The aqueous suspension components may be combined in any suitable sequence and may be sufficiently mixed to form a homogeneous distribution of the suspension components. The aqueous suspension can be maintained in an autoclave under autogenous pressure (from the components or from the components plus an addition of a gas purge into the vessel prior to heating), or in another suitable vessel, under agitation such as by stirring, tumbling and/or shaking. Mixing of the aqueous suspension components may be conducted between about 20-60, 20-50 or 20-40° C.

The steps of incision and reassembly may occur during hydrothermal treatment to form a solid product (the hierarchically ordered crystalline microporous material) suspended in a supernatant (mother liquor). The hydrothermal treatment may be conducted: for a period of about 4-168, 12-168, 24-168, 4-96, 12-96 or 24-96 hours; at a temperature of about 70-250, 70-210, 70-180, 70-150, 90-250, 90-210, 90-180, 90-150, 110-250, 110-210, 110-180 or 110-150° C.; and at a pressure of about atmospheric to autogenous pressure. In embodiments, hydrothermal treatment may occur in a vessel that is the same as that used for mixing, or the aqueous suspension may be transferred to another vessel (such as another autoclave or low-pressure vessel). In embodiments, the vessel used for hydrothermal treatment may be static. In embodiments, the vessel used for hydrothermal treatment may be under agitation that is sufficient to suspend the components.

Subsequent to the hydrothermal treatment, the hierarchically ordered crystalline microporous material may be recovered. The solids may be recovered using known techniques such as centrifugation, decanting, gravity, vacuum filtration, filter press, or rotary drums. The recovered hierarchically ordered crystalline microporous material may be dried, for example at a temperature of about 50-150, 50-120, 80-150 or 80-120° C., at atmospheric pressure or under vacuum conditions, for a time of about 0.5-96, 12-96 or 24-96 hours.

In embodiments, the dried HOCMM having well-defined long-range mesoporous ordering is calcined, for example to remove supramolecular templates that remain in the mesopores and other constituents from the mesopores and/or the discrete zeolite cell micropores. The conditions for calcination in embodiments, in which it is carried out can include temperatures in the range of about 350-650, 350-600, 350-550, 500-650, 500-600 or 500-550° C., atmospheric pressure or under vacuum, and a time period of about 2.5-24, 2.5-12, 5-24 or 5-12 hours. Calcining can occur with ramp rates in the range of from about 0.1-10, 0.1-5, 0.1-3, 1-10, 1-5 or 1-3° C. per minute. In embodiments, calcination can have a first step ramping to a temperature of between about 100-150° C. with a holding time of from about 1.5-6 or 1-12 hours (at ramp rates of from about 0.1-5, 0.1-3, 1-5 or 1-3° C. per min) before increasing to a higher temperature with a final holding time in the range of about 1.5-6 or 1-12 hours.

In embodiments, the supernatant remaining after recovery of product from the system may recovered, and all or a portion thereof can be reused as all or a portion of the solution in a subsequent process for synthesis of the hierarchically ordered crystalline microporous material. In this embodiment, recovered supernatant used in subsequent process is referred to as supernatant from a prior synthesis. In embodiments, a new synthesis can occur using supernatant from a prior synthesis together with the parent CMM. In embodiments, a new synthesis can occur using supernatant from a prior synthesis together with the parent CMM and an additional quantity of make-up alkaline reagent (for example urea). In embodiments, a new synthesis can occur using supernatant from a prior synthesis together with the parent CMM and an additional quantity of make-up supramolecular template. In embodiments, a new synthesis can occur using supernatant from a prior synthesis together with the parent CMM and an additional quantity of make-up silica source material, an alumina source material, or both. In embodiments, a new synthesis can occur using supernatant from a prior synthesis together with parent CMM and an additional quantity of make-up ionic co-solute. In embodiments, a new synthesis can occur using supernatant from a prior synthesis together with parent CMM and an additional quantity of make-up alkaline reagent (for example urea), and/or make-up supramolecular template, and/or make-up silica source material, and/or makeup alumina source material, and/or optional make-up ionic co-solute.

The composition of matter recovered as described herein are hierarchically ordered crystalline microporous material (such as zeolites) having a greater degree of mesoporosity than the parent CMM, and having an SAR that is at least 0.5 different than the parent CMM. In embodiments, the hierarchically ordered crystalline microporous material may have a mesopore vol % of at least 70%, at least 75%, at least 80%, at least 81%, at least 82%, at least 83%, at least 84%, or at least 85%.

The mesoporosity of the hierarchically ordered crystalline microporous material may be characterized by defined mesoporous channel directions with zeolite micropore channels in the walls of the mesostructure.

The hierarchically ordered crystalline microporous material recovered from the synthesis may possess the supramolecular template as described herein in the mesopores (that is, prior to calcination or extraction of the supramolecular template). In embodiments, the hierarchically ordered crystalline microporous material recovered from synthesis possesses micelles of supramolecular template as described herein in the mesopores (that is, prior to calcination or extraction of the supramolecular template). The composition of matter recovered as described herein may retain the structural integrity of the microporous zeolite structure by controlled incision of the parent zeolite followed by controlled reassembly of the zeolite oligomers under a controlled micellar curvature to yield the HOCMMs with defined mesoporous symmetry.

This well-defined long-range mesoporosity is elusive in the field of hierarchically ordered zeolites. The long-range order is defined by secondary peaks associated with the periodic arrangement of mesopores in x-ray diffraction (XRD) patterns for the given mesophase, and/or by observations in microscopy, as demonstrated in the examples herein. These peaks associated with the mesoporous traits of the products are observed at low 20 angles. The material also exhibits high-angle peaks associated with the zeolites and are observed at high 2-theta angles. In embodiments, the low-angle peaks refer to those occurring at 20 angles less than about 6°.

In embodiments herein, long-range mesoporous ordering of HOCMMs produced according to the methods described herein are characterized by the mesopore periodicity repeating over a length of greater than about 50 nm.

In embodiments herein, HOCMMs produced according to the methods described herein may be cubic mesophase possessing Ia-3d symmetry and long-range mesoporous ordering is characterized by secondary XRD peaks associated with the periodic arrangement of mesopores are present at one or more of the (220), (321), (400), (420) and (332) reflections. In embodiments, herein, HOCMMs produced according to the methods described herein may be hexagonal mesophase possessing p6 mm symmetry and long-range mesoporous ordering is characterized by secondary peaks in XRD that are present at (11) and/or (20) reflections. In embodiments, herein, HOCMMs produced according to the methods described herein may be lamellar mesophase possessing p2 symmetry and long-range mesoporous ordering is characterized by secondary peaks in XRD that are present at a (200) reflection.

In embodiments herein, the hierarchically ordered crystalline microporous material may have a surface area of about 200-1500, 200-1000, 200-900, 400-1500, 400-1000, 400-900, 500-1500, 500-1000 or 500-900 m²/g. In embodiments, herein, the hierarchically ordered crystalline microporous material may have a mesoporous pore size of about 2-50, 2-20 or 2-10 nm. In embodiments, herein, the hierarchically ordered crystalline microporous material may have a silica-to-alumina ratio of about 2.5-1500, 3-1500, 4-1500, 5-1500, 6-1500, 2.5-1000, 3-1000, 4-1000, 5-1000, 6-1000, 2.5-500, 3-500, 4-500, 5-500, 6-500, 2.5-100, 3-100, 4-100, 5-100, or 6-100. In embodiments, herein, the hierarchically ordered crystalline microporous material may have a total pore volume of about 0.01-1.50, 0.01-1.0, 0.01-0.75, 0.01-0.65, 0.1-1.50, 0.1-1.0, 0.1-0.75, 0.1-0.65, 0.2-1.50, 0.2-1.0, 0.2-0.75, 0.2-0.65, 0.3-1.50, 0.3-1.0, 0.3-0.75 or 0.3-0.65 cc/g.

In embodiments herein, a product produced by the above method and demonstrated in an example herein is characterized by a mesophase having cubic symmetry. In embodiments, the product is a 3D-cubic ordered mesoporous zeolite. HOCMMs with the mesophase having cubic symmetry are characterized by cubic mesoporous channel directions with CMM micropore channels in the walls of the mesostructure. The cubic mesophase can possess one of Ia-3d, Fm-3m, Pm-3n, Pn-3m or Im-3m symmetry. In embodiments, herein the cubic mesophase possesses Ia-3d symmetry and the secondary XRD peaks associated with the periodic arrangement of mesopores are present at one or more of the (220), (321), (400), (420) and (332) reflections. In embodiments, herein the cubic mesophase possesses Ia-3d symmetry and the high-degree of long-range cubic mesophase ordering is observable by microscopy viewed by the electron beam down a suitable zone axis, for example the [311], [111] or [110] zone axes. In the example herein, nitrate salt (NO₃⁻) is used as an ionic co-solute to generate the mesophase having cubic symmetry. In these embodiments CMM structures are arranged in a cubic symmetry on the meso-scale, where the CMM particles (regardless of their atomic-level symmetry or structure) are arranged around micelles (on the meso-scale), and whereby the micelles are arranged exhibiting cubic symmetry. Accordingly, HOCMM having a cubic mesophase includes CMM characterized by atomic-level symmetry and possessing micropores that are inherent to that type of CMM, arranged in a cubic symmetry at the meso-scale level with mesopores, wherein walls of the mesopores and a mass of the mesostructure between mesopores is characterized by said CMM (e.g., crystalline zeolite). This is created as described herein by forming oligomers of the underlying CMM and arranging those oligomers arranged around micelles exhibiting cubic symmetry on the meso-scale. In one embodiment a HOCMM is provided including MFI zeolite having atomic-level orthorhombic symmetry arranged in a cubic symmetry meso-scale, wherein during synthesis of hierarchically ordered zeolite from parent MFI zeolite, oligomers of the parent MFI zeolite are formed and arranged around micelles exhibiting cubic symmetry on the meso-scale. In one embodiment a HOCMM is provided including CHA zeolite having atomic-level trigonal symmetry arranged in a cubic symmetry meso-scale, wherein during synthesis of hierarchically ordered zeolite from parent CHA zeolite, oligomers of the parent CHA zeolite are formed and arranged around micelles exhibiting cubic symmetry on the meso-scale. In one embodiment a HOCMM is provided including BEA zeolite having atomic-level tetragonal symmetry arranged in a cubic symmetry meso-scale, wherein during synthesis of hierarchically ordered zeolite from parent BEA zeolite, oligomers of the parent BEA zeolite are formed and arranged around micelles exhibiting cubic symmetry on the meso-scale. In one embodiment a HOCMM is provided including MWW zeolite having atomic-level hexagonal symmetry arranged in a cubic symmetry meso-scale, wherein during synthesis of hierarchically ordered zeolite from parent MWW zeolite, oligomers of the parent MWW zeolite are formed and arranged around micelles exhibiting cubic symmetry on the meso-scale. In one embodiment a HOCMM is provided including FAU zeolite having atomic-level cubic symmetry arranged in a cubic symmetry meso-scale, wherein during synthesis of hierarchically ordered zeolite from parent FAU zeolite, oligomers of the parent FAU zeolite are formed and arranged around micelles exhibiting cubic symmetry on the meso-scale.

In embodiments herein, a product produced by the above method and demonstrated in an example herein is characterized by a mesophase having hexagonal symmetry. In embodiments, the product is a 2D-hexagonally ordered mesoporous zeolite. HOCMMs with the mesophase having hexagonal symmetry are characterized by hexagonal mesoporous channel directions with CMM micropore channels in the walls of the mesostructure. The hexagonal mesophase can possess one of p6m, p6 mm or p63/mmc symmetry. In embodiments, herein the hexagonal mesophase possesses p6 mm symmetry and secondary XRD peaks associated with the periodic arrangement of mesopores are present at one or more of the (11) and (20) reflections. In embodiments, herein the hexagonal mesophase possesses p6 mm symmetry and secondary XRD peaks are present at both the (11) and (20) reflections. In embodiments, herein the hexagonal mesophase possesses p6 mm symmetry and the high-degree of long-range hexagonal p6 mm mesophase ordering is observable by microscopy viewed by the electron beam perpendicular to the pores down the zone axis and/or parallel to the pores down the zone axis. In these embodiments CMM structures are arranged in a hexagonal p6 mm symmetry on the meso-scale, where the CMM particles (regardless of their atomic-level symmetry or structure) are arranged around micelles (on the meso-scale), and whereby the micelles are arranged exhibiting hexagonal symmetry. Accordingly, HOCMM having a hexagonal p6 mm mesophase includes CMM characterized by atomic-level symmetry and possessing micropores that are inherent to that type of CMM, arranged in a hexagonal p6 mm symmetry at the meso-scale level with mesopores, wherein walls of the mesopores and a mass of the mesostructure between mesopores is characterized by said CMM (e.g., crystalline zeolite). This is created as described herein by forming oligomers of the underlying CMM and arranging those oligomers arranged around micelles exhibiting hexagonal symmetry on the meso-scale. In one embodiment a HOCMM is provided including MFI zeolite having atomic-level orthorhombic symmetry arranged in a hexagonal p6mm symmetry meso-scale, wherein during synthesis of hierarchically ordered zeolite from parent MFI zeolite, oligomers of the parent MFI zeolite are formed and arranged around micelles exhibiting hexagonal symmetry on the meso-scale. In one embodiment a HOCMM is provided including CHA zeolite having atomic-level trigonal symmetry arranged in a hexagonal p6 mm symmetry meso-scale, wherein during synthesis of hierarchically ordered zeolite from parent CHA zeolite, oligomers of the parent CHA zeolite are formed and arranged around micelles exhibiting hexagonal symmetry on the meso-scale. In one embodiment a HOCMM is provided including BEA zeolite having atomic-level tetragonal symmetry arranged in a hexagonal p6 mm symmetry meso-scale, wherein during synthesis of hierarchically ordered zeolite from parent BEA zeolite, oligomers of the parent BEA zeolite are formed and arranged around micelles exhibiting hexagonal symmetry on the meso-scale. In one embodiment a HOCMM is provided including MWW zeolite having atomic-level hexagonal symmetry arranged in a hexagonal p6 mm symmetry meso-scale, wherein during synthesis of hierarchically ordered zeolite from parent MWW zeolite, oligomers of the parent MWW zeolite are formed and arranged around micelles exhibiting hexagonal symmetry on the meso-scale. In one embodiment a HOCMM is provided including FAU zeolite having atomic-level cubic symmetry arranged in a hexagonal p6 mm symmetry meso-scale, wherein during synthesis of hierarchically ordered zeolite from parent FAU zeolite, oligomers of the parent FAU zeolite are formed and arranged around micelles exhibiting hexagonal symmetry on the meso-scale.

In embodiments herein, a product produced by the above method and demonstrated in an example herein is characterized by a high-degree of long-range lamellar mesophase ordering. In embodiments, the product is a mesoporous zeolite of lamellar mesophase ordering. HOCMMs with the mesophase having lamellar symmetry are characterized by lamellar mesoporous channel directions with CMM micropore channels in the walls of the mesostructure. In these embodiments CMM structures are arranged in a lamellar symmetry on the meso-scale, where the CMM particles (regardless of their atomic-level symmetry or structure) are arranged around micelles (on the meso-scale), and whereby the micelles are arranged exhibiting lamellar symmetry. In embodiments, lamellar symmetry is p2, p1 or pm symmetry. In embodiments, lamellar symmetry is p2 symmetry with a secondary XRD peak associated with the periodic arrangement of mesopores present at least at the (200) reflection. In embodiments, the high-degree of long-range lamellar mesophase ordering is observable by microscopy viewed by the electron beam in parallel or perpendicular directions to the zone axis. Accordingly, HOCMM having a lamellar mesophase includes CMM characterized by atomic-level symmetry and possessing micropores that are inherent to that type of CMM, arranged in a lamellar symmetry at the meso-scale level with mesopores, wherein walls of the mesopores and a mass of the mesostructure between mesopores is characterized by said CMM. This is created as described herein by forming oligomers of the underlying CMM and arranging those oligomers arranged around micelles exhibiting lamellar symmetry on the meso-scale. In one embodiment a HOCMM is provided including MFI zeolite having atomic-level orthorhombic symmetry arranged in a lamellar symmetry meso-scale, wherein during synthesis of hierarchically ordered zeolite from parent MFI zeolite, oligomers of the parent MFI zeolite are formed and arranged around micelles exhibiting lamellar symmetry on the meso-scale. In one embodiment a HOCMM is provided including CHA zeolite having atomic-level trigonal symmetry arranged in a lamellar symmetry meso-scale, wherein during synthesis of hierarchically ordered zeolite from parent CHA zeolite, oligomers of the parent CHA zeolite are formed and arranged around micelles exhibiting lamellar symmetry on the meso-scale. In one embodiment a HOCMM is provided including BEA zeolite having atomic-level tetragonal symmetry arranged in a lamellar symmetry meso-scale, wherein during synthesis of hierarchically ordered zeolite from parent BEA zeolite, oligomers of the parent BEA zeolite are formed and arranged around micelles exhibiting lamellar symmetry on the meso-scale. In one embodiment a HOCMM is provided including MWW zeolite having atomic-level hexagonal symmetry arranged in a lamellar symmetry meso-scale, wherein during synthesis of hierarchically ordered zeolite from parent MWW zeolite, oligomers of the parent MWW zeolite are formed and arranged around micelles exhibiting lamellar symmetry on the meso-scale. In one embodiment a HOCMM is provided including FAU zeolite having atomic-level cubic symmetry arranged in a lamellar symmetry meso-scale, wherein during synthesis of hierarchically ordered zeolite from parent FAU zeolite, oligomers of the parent FAU zeolite are formed and arranged around micelles exhibiting lamellar symmetry on the meso-scale.

In embodiments which CMM structures are arranged in a lamellar symmetry on the meso-scale, lamellar symmetry is primarily observed in the as-made materials (that is, prior to calcination). In the absence of CMM interconnections between lamellar structures, there is a tendency to collapse during calcination. In embodiments, CMMs such as zeolite crystalline structures arranged in a lamellar symmetry provided herein can be exfoliated to form sheets of the CMMs, for example zeolitic nanosheets. In embodiments, CMMs such as zeolite crystalline structures arranged in a lamellar symmetry provided herein can retain a lamellar symmetry by using pillaring techniques known in the art, for example wherein a silica source such as tetraethyl orthosilicate (TEOS) is condensed amidst the lamellar structures and crystallized during calcination to retain lamellar structure and prevent collapse (see, for example, Na, K. et al. “Pillared MFI Zeolite Nanosheets of a Single-unit-cell Thickness.” J. Am. Chem. Soc. 132, 4169-4177). In embodiments, in which the HOCMMs formed herein possess meso-scale, lamellar symmetry with a pillared lamellar structure, they can be used, for example, as a catalytic material or catalytic support material.

HOCMMs produced according to the present disclosure may be effective as catalysts, or components of catalysts, in hydrocracking of hydrocarbon oil. The HOCMM can be used as a support having loaded thereon one or more active metal components as a hydrocracking catalyst. The active metal components are loaded, for example, carried on surfaces including the mesopore wall surfaces, micropore wall surfaces or mesopore and micropore wall surfaces; the active metal components are loaded according to known methods, such as providing an aqueous solution of the active metal components and subjecting HOCMM as catalyst support material to immersion, incipient wetness, and evaporative, or any other suitable method. In embodiments, the CMM of the HOCMM comprises zeolite. In embodiments, the CMM of the HOCMM comprises one or more zeolite types AEI, *BEA, CHA, FAU, MFI, MOR, LTL, LTA or MWW. In embodiments, the CMM of the HOCMM comprises FAU zeolite.

The content of the HOCMM and the active metal component are appropriately determined according to the objective. In embodiments, a hydrocracking catalyst comprises as a support the HOCMM and an inorganic oxide component, typically as a binder and/or granulating agent. For example, support particles (prior to loading of one or more hydrocracking active metal components) can contain HOCMM in the range of about 0.1-99, 0.1-90, 0.1-80, 0.1-70, 0.1-50, 0.1-40, 2-99, 2-90, 2-80, 2-70, 2-50, 2-40, 20-100, 20-90, 20-80, 20-70, 20-50, or 20-40 wt %, with the remaining content being the inorganic oxide. In embodiments, support particles (prior to loading of one or more hydrocracking active metal components) can comprise HOCMM in the range of about 0.1-99, 0.1-90, 0.1-80, 0.1-70, 0.1-50, 0.1-40, 2-99, 2-90, 2-80, 2-70, 2-50, 2-40, 20-100, 20-90, 20-80, 20-70, 20-50, or 20-40 wt %, with the remaining content being the inorganic oxide and one or more other zeolitic materials.

As the inorganic oxide component, any material used in hydrocracking or other catalyst compositions in the related art can be used. Examples thereof include alumina, silica, titania, silica-alumina, alumina-titania, alumina-zirconia, alumina-boria, phosphorus-alumina, silica-alumina-boria, phosphorus-alumina-boria, phosphorus-alumina-silica, silica-alumina-titania, silica-alumina-zirconia, alumina-zirconia-titania, phosphorous-alumina-zirconia, alumina-zirconia-titania and phosphorus-alumina-titania.

The active metal component can include one or more metals or metal compounds (oxides or sulfides) known in the art of hydrocracking, including those selected from the Periodic Table of the Elements IUPAC Groups 6, 7, 8, 9 and 10. In embodiments, the active metal component is one or more of Mo, W, Co or Ni (oxides or sulfides). The additional active metal component may be contained in catalyst in effective concentrations. For example, total active component content in hydrocracking catalysts can be present in an amount as is known in the related art, for example about 0.01-40, 0.1-40, 1-40, 2-40, 5-40, 0.01-30, 0.1-30, 1-30, 2-30, 5-30, 0.01-20, 0.1-20, 1-20, 2-20 or 5-20 W % in terms of metal, oxide or sulfide. In embodiments, active metal components are loaded using a solution of oxides, and prior to use, the hydrocracking catalysts are sulfided.

### EXAMPLES

The HOCMMs produced in the examples herein exhibit a remarkable degree of well-defined long-range mesoporous ordering, as given by the low-angle XRD patterns. The parent zeolites used in the examples and comparative examples possesses the FAU framework, zeolite Y (obtained from Zeolyst International, product name CBV 720) and is referred to herein as zeolite H-Y, having a SAR of about 30, and zeolite Y (obtained from Zeolyst International, product name CBV 760) and is referred to herein as zeolite H-Y60, having a SAR of about 60. While the examples are shown with respect to these particular zeolites, the methods herein can be applied to a parent CMM from another source and of another type as described herein, whether obtained from a commercial manufacturer obtained from a separate synthesis process. Accordingly, the resulting compositions of matter have the mesoporous structure with microporosity and CMM structure corresponding to the parent CMM.

Characterizations herein were carried out as follows. Powder x-ray diffraction patterns were obtained using a Bruker D8 twin diffractometer, operating at 40 kV and 40 mA having Cu Ka radiation (λ, =0.154 nm) and a step-size of 0.02. N₂ physisorption measurements were conducted at 77 K using a Micromeritics ASAP 2420 instrument. All samples were degassed at 350° C. for 12 h before the analysis. The specific surface areas and pore size distributions were calculated using the Brunauer-Emmett-Teller (BET) and non-local density functional theory (NLDFT) models. The t-plot method was used to calculate the micropore volume. High-resolution transmission electron microscopy (TEM) studies were undertaken using a PEI-Titan ST electron microscope operated at 300 kV.

Example 1A: A quantity of 2.0 grams of zeolite H-Y was dispersed in 56.6 grams of water under constant stirring. To this solution, 0.77 grams of cetyltrimethylammonium bromide (CTAB) was added and further stirred for 0.5 hours. Subsequently, 4.75 grams of aqueous ammonium hydroxide (30 wt. %) was added dropwise to the mixture under stirring. The resultant solution was further stirred for 0.5 hours, followed by hydrothermal treatment at 130° C. for 24 hours. The resulting solids were filtered, washed with water and dried at 120° C. for 24 hours. The synthesized product was calcined in air at 550° C. for 6 hours with a ramp rate of 60° C./hour to yield Y-AH-CT (in which Y refers to zeolite Y, AH refers to ammonium hydroxide and CT refers to CTAB).

Example 1B: A procedure for synthesis of 2D-hexagonally ordered mesoporous FAU-type zeolites is provided. A quantity of 2.0 grams of zeolite H-Y was dispersed in 56.6 grams of water under constant stirring. To this solution, 3.0 milliliters of organosilane, dimethyloctadecyl (3-trimethoxysilyl-propyl)-ammonium chloride (42.0 wt % in methanol), was added and further stirred for 0.5 hours. Subsequently, 4.75 grams of aqueous ammonium hydroxide solution (30 wt. %) was added dropwise to the mixture under stirring. The resultant solution was further stirred for 0.5 hours, followed by hydrothermal treatment at 130° C. for 24 hours. The resulting solids were filtered, washed with water and dried at 120° C. for 24 hours. The synthesized product was calcined in air at 550° C. for 6 hours with a ramp rate of 60° C./hour to yield Y-AH-TMS (in which Y refers to zeolite Y, AH refers to ammonium hydroxide and TMS refers to dimethyloctadecyl (3-trimethoxysilyl-propyl)-ammonium chloride).

Example 1C: A procedure for synthesis of 2D-hexagonally ordered mesoporous FAU-type zeolites is provided. A quantity of 1.2 grams of urea was dissolved in 60.0 g of water to form a homogeneous solution. To this solution 0.33 g of ammonium sulfate (NH₄)₂SO₄) was added as a source of ionic co-solute, and stirred until homogeneous. To this mixture, 2.0 g of zeolite H-Y was added and stirred for 10 minutes. Subsequently, 3.0 milliliters of organosilane, dimethyloctadecyl (3-trimethoxysilyl-propyl)-ammonium chloride (42.0 wt % in methanol), was added. The resulting solution was stirred for 0.5 hours, followed by hydrothermal treatment at 130° C. for 72 hours. The resulting solids were filtered, washed with water and dried at 120° C. for 24 hours. The synthesized product was calcined in air at 550° C. for 6 hours with a ramp rate of 60° C./hour to yield Y-U-S-TMS (in which Y refers to zeolite Y, U refers to urea, S refers to sulfate and TMS refers to dimethyloctadecyl (3-trimethoxysilyl-propyl)-ammonium chloride). Structural and textural properties of Y-U-S-TMS are provided in Table 3.

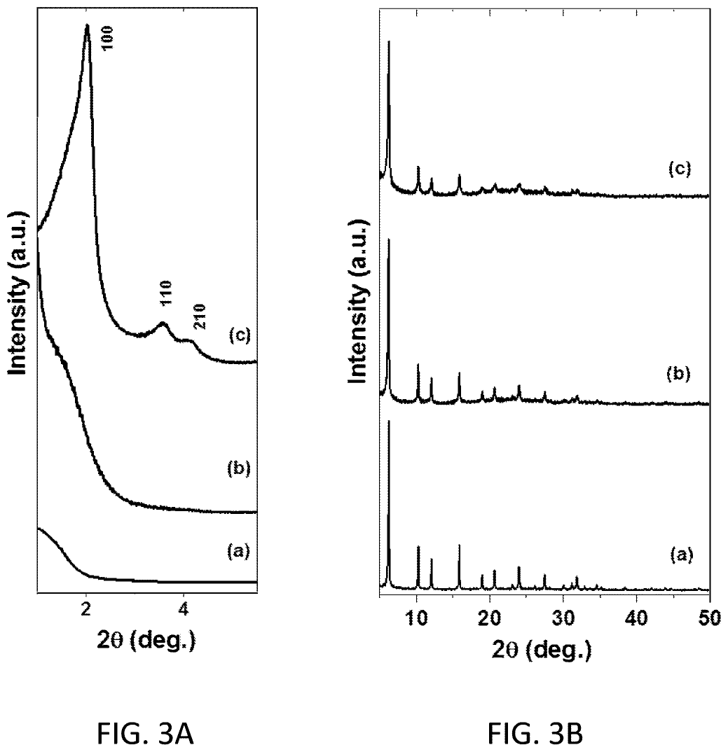

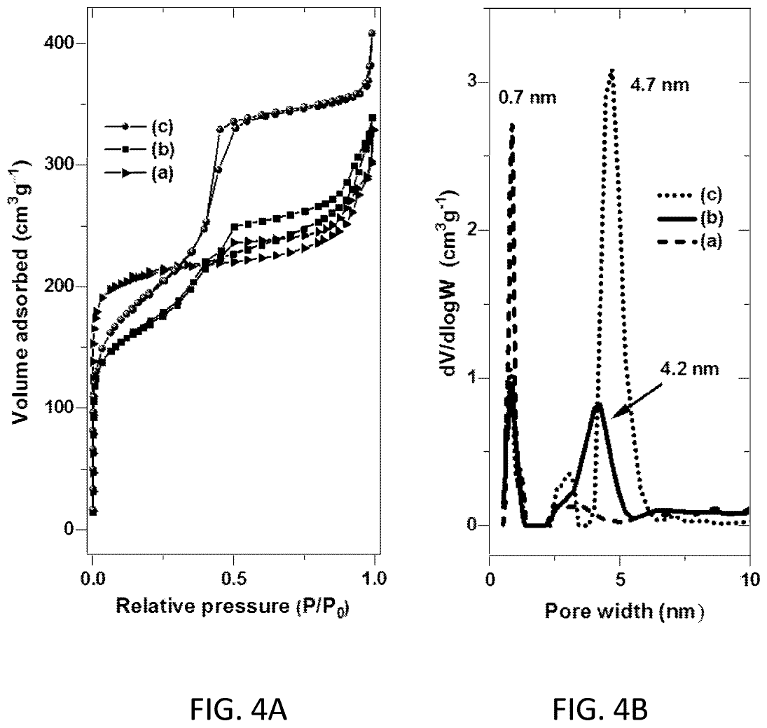

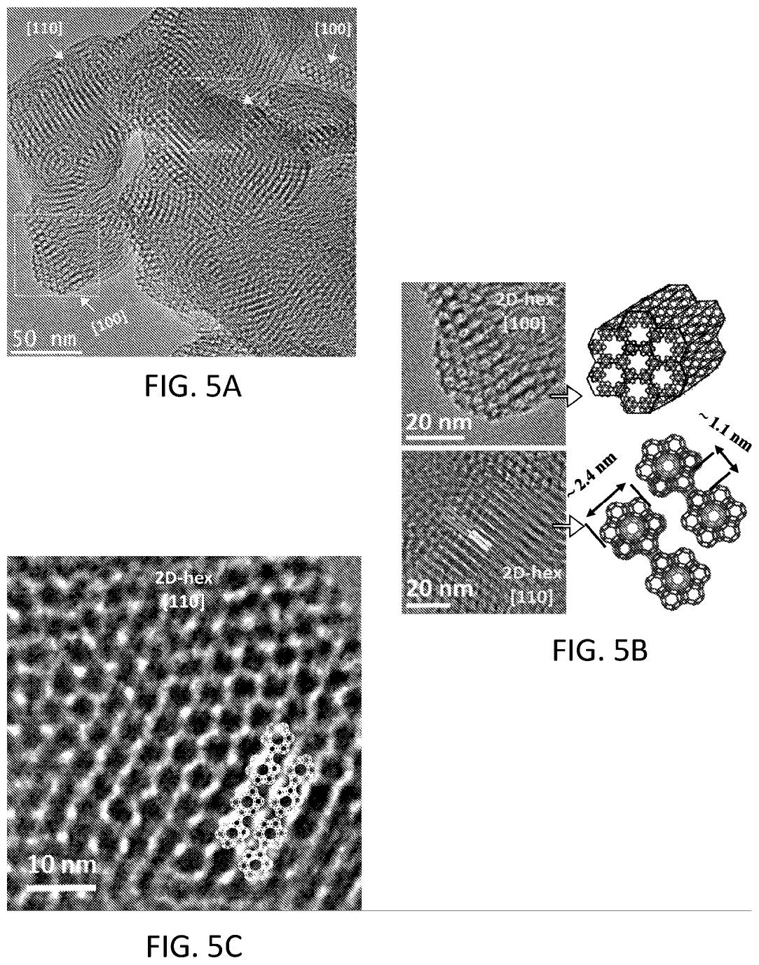

In the Example 1B and 1C, the product hierarchically ordered zeolites are 2D-hexagonally ordered mesoporous FAU-type zeolites, having mesoporous channels, arranged in a hexagonal manner, as observed in the [100] and [110] directions with FAU micropore channels in the walls and mass of the mesostructure between mesopores. FIG. 3A depicts low-angle XRD patterns, FIG. 3B depicts high-angle XRD patterns, FIG. 4A depicts N₂ physisorption isotherms and FIG. 4B depicts NLDFT pore-size distributions, wherein “a” corresponds to commercial-USY (Zeolite H-Y), “b” corresponds to Y-AH-CT, and “c” corresponds to Y-AH-TMS: FIG. 5A to FIG. 5C are transmission electron microscopy (TEM) micrographs of Y-AH-TMS showing hexagonal mesoporous channels in the [100] and [110] directions with FAU micropore channels in the walls of the mesostructure, wherein: FIG. 5A shows the TEM micrograph at a scale of 50 nanometers; FIG. 5B shows the TEM micrographs in the [100] direction and in the [110] direction at a scale of 20 nanometers, and also depicts corresponding schematic diagrams and unit cell dimensions; and FIG. 5C shows the TEM micrograph at a scale of 10 nanometers (with an overlaying schematic diagram of the underlying zeolite structure). The high-degree of long-range ordering is apparent from FIG. 3A, where low-angle XRD pattern “c” exhibits Bragg's reflections at angles corresponding to 100, 110 and 210 planes, indicative of hexagonal mesopore symmetry in the Y-AH-TMS. Conversely, low-angle XRD pattern “b” exhibits disordered mesoporosity despite having a uniform pore size distribution (PSD) from the corresponding N₂ physisorption isotherm, as is apparent in FIG. 3A and FIG. 4A, attributed to non-homogeneous zeolite dissolution and restricted supramolecular self-assembly. The retention of the underlying zeolite structure is apparent from FIG. 3B, where high-angle XRD patterns are consistent with those for the parent zeolite, FAU zeolite, for all samples. FIG. 4A and FIG. 4B depict N₂ physisorption isotherms and pore-size distributions of prepared zeolites. Y-AH-TMS (denoted “c” in FIG. 4A and FIG. 4B) demonstrates excellent hierarchically ordered mesoporosity as indicated by characteristic type-IV isotherm with Hl hysteresis. In addition, a high mesopore volume and narrow pore-size distribution further supports the presence of long-range ordered mesoporosity.

Example 2A: A quantity of 1.2 grams of urea was dissolved in 60.0 g of water to form a homogeneous solution. To this mixture, 2.0 g of zeolite H-Y was added and stirred for 10 minutes. Subsequently, 3.0 milliliters of an organosilane, dimethyloctadecyl (3-trimethoxysilyl-propyl)-ammonium chloride (42.0 wt % in methanol), was added. The resulting solution was stirred for 0.5 hours, followed by hydrothermal treatment at 130° C. for 72 hours. The resulting mixture was filtered, washed with water and dried at 120° C. for 24 hours. The synthesized product was calcined in air at 550° C. for 6 hours with a ramp rate of 60° C./hour to yield Y-U-TMS (in which Y refers to zeolite Y, U refers to urea and TMS refers to dimethyloctadecyl (3-trimethoxysilyl-propyl)-ammonium chloride).

Example 2B: A procedure for synthesis of 3D-cubic ordered mesoporous FAU-type zeolites is provided. A quantity of 1.2 grams of urea was dissolved in 60.0 g of water to form a homogeneous solution. To this mixture, 0.2 g of ammonium nitrate (NH₄NO₃) was added as a source of ionic co-solute, and stirred to form a homogeneous solution. 2.0 g of zeolite H-Y was added and stirred for 10 minutes. Subsequently, 3.0 milliliters of an organosilane, dimethyloctadecyl (3-trimethoxysilyl-propyl)-ammonium chloride (42.0 wt % in methanol), was added. The resulting solution was stirred for 0.5 hours, followed by hydrothermal treatment at 130° C. for 72 hours. The resulting solids were filtered, washed with water and dried at 120° C. for 24 hours. The synthesized product was calcined in air at 550° C. for 6 hours with a ramp rate of 60° C./hour to yield Y-U-N-TMS (in which Y refers to zeolite Y, N refers to nitrate, U refers to urea and TMS refers to dimethyloctadecyl (3-trimethoxysilyl-propyl)-ammonium chloride). Structural and textural properties of Y-U-N-TMS are provided in Table 3.

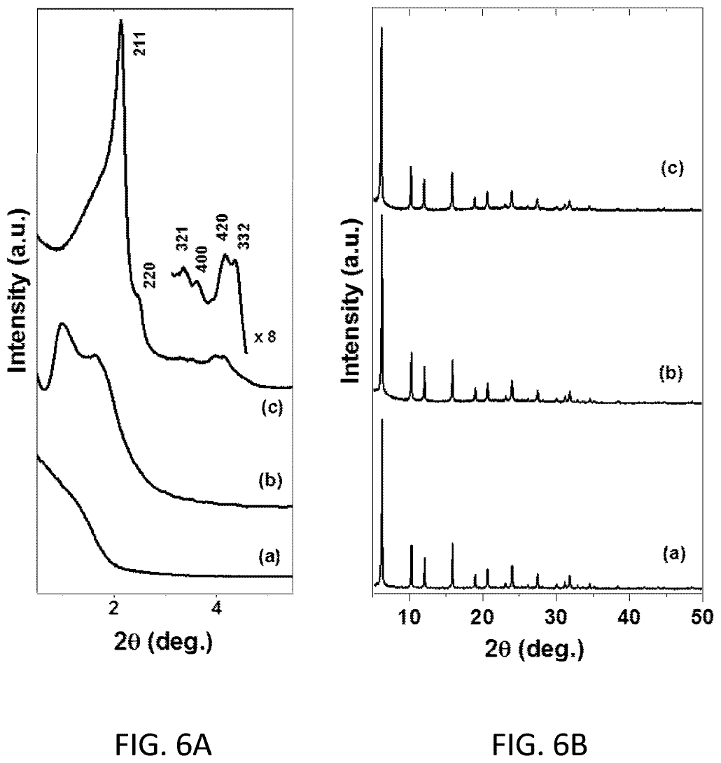

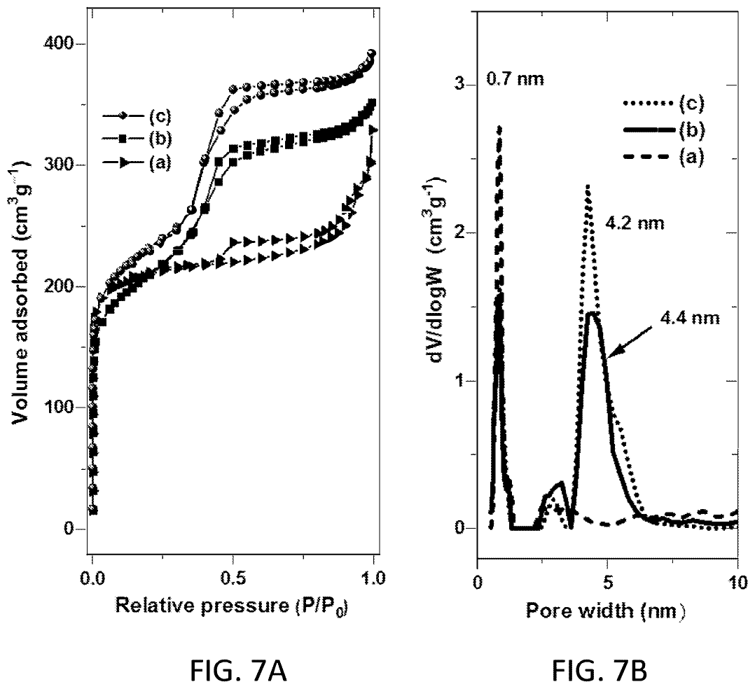

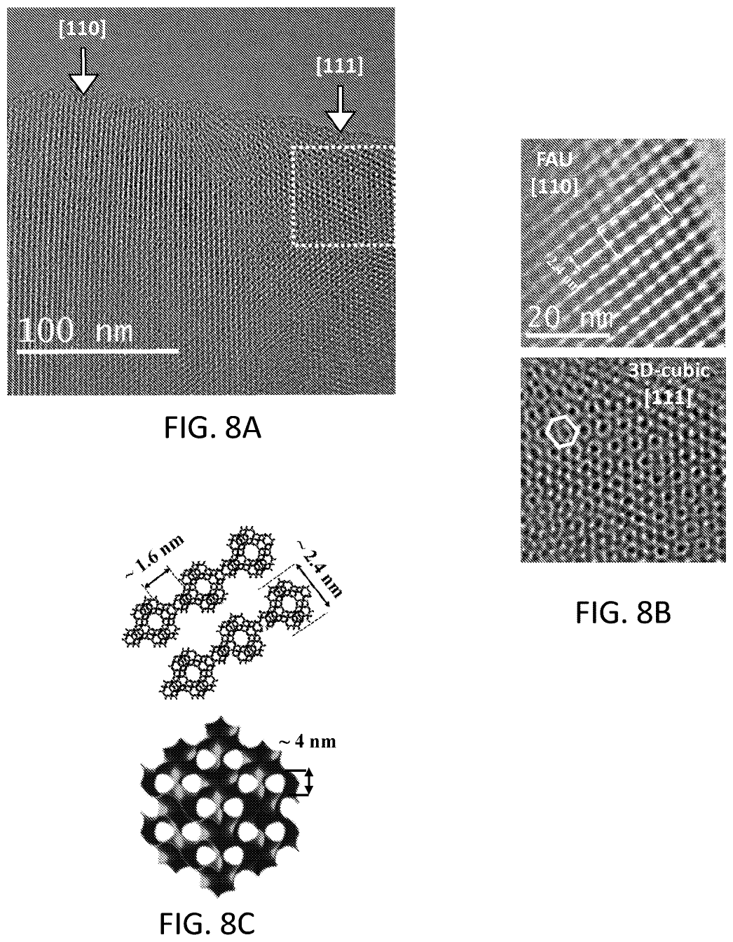

When comparing the Examples 2A and 2B, the benefit of the ionic co-solute contribution of the nitrate is apparent. The ionic co-solute serves to influence the cubic micelle shape by the Hofmeister effect, around with the FAU-type zeolite oligomers are arranged. FIG. 6A depicts low-angle XRD patterns, FIG. 6B depicts high-angle XRD patterns, FIG. 7A depicts N₂ physisorption isotherms and FIG. 7B depicts DFT pore-size distributions, wherein “a” corresponds to commercial-USY (Zeolite H-Y), “b” corresponds to Y-U-TMS, and “c” corresponds to Y-U-N-TMS: In the Example 2A there is a degree of periodicity of mesopore arrangement possibly from either a bimodal system or a structure collapse, however, there is a significant lack of any long-range ordering as compared with the Example 2B having the nitrate anion where, in FIG. 6A, it is observed by low angle XRD showing reflections characteristic of gyrodial bicontinuous (cubic) mesopore structure (Ia-3d). In the Example 2B, the product hierarchically ordered zeolite is a 3D-cubic ordered mesoporous FAU-type zeolite, having cubic mesoporous channels present in the [100] and [110] directions with FAU micropore channels in the walls and mass of the mesostructure between mesopores. FIG. 8A to FIG. 8B are TEM micrographs of Y-U-N-TMS showing cubic mesoporous channels in the and directions with FAU micropore channels in the walls of the mesostructure, wherein: FIG. 8A shows the TEM micrograph at a scale of 100 nanometers; FIG. 8B shows the TEM micrograph in the [110] direction and in the [111] direction at a scale of 20 nanometers; and FIG. 8C depicts a FAU unit cell schematic and dimensions and their arrangement to provide long-range mesoporous ordering. The high-degree of long-range ordering is apparent from FIG. 6A, where low-angle XRD patterns exhibit Bragg's reflections 211, 220, 321, 400, 420 and 332, which are characteristic of bicontinuous gyroid (cubic) (Ia-3d) mesopore symmetry (where the reflections at 321, 400, 420 and 332 are show at 8 times magnification). The retention of the underlying zeolite structure is apparent from FIG. 6B, where high-angle XRD patterns are consistent with those for the parent zeolite, FAU zeolite. FIG. 7A and FIG. 7B depict the N₂ physisorption isotherms and pore-size distributions of prepared zeolites. Y-U-N-TMS has shown excellent hierarchically ordered mesoporosity as indicated by characteristic type-IV isotherm with H1 hysteresis. In addition, a high mesopore volume and narrow pore-size distribution further supports the presence of long-range ordered mesoporosity.

Example 3A: A procedure for synthesis of 2D-lamellar ordered mesoporous FAU-type zeolites is provided. A quantity of 1.2 grams of urea was dissolved in 60.0 g of water to form a homogeneous solution. To this mixture, 2.0 g of zeolite H-Y was added and stirred. 0.92 g of sodium perchlorate (NaClO₄) was added and stirred for 10 minutes. Subsequently, 3.0 milliliters of an organosilane, dimethyloctadecyl (3-trimethoxysilyl-propyl)-ammonium chloride (42.0 wt % in methanol) was added. The resulting solution was stirred for 0.5 hours, followed by hydrothermal treatment at 130° C. for 72 hours. The resulting solids were filtered, washed with water and dried at 120° C. for 24 hours. The synthesized product was calcined in air at 550° C. for 6 hours with a ramp rate of 60° C./hour to yield Y-U-C-TMS (in which Y refers to zeolite Y, C refers to perchlorate, U refers to urea and TMS refers to dimethyloctadecyl (3-trimethoxysilyl-propyl)-ammonium chloride). Structural and textural properties of Y-U-C-TMS are provided in Table 3.

Example 3B: A procedure follows that of Example 3A, except that a quantity of 4.75 g NH₄OH is used as the alkaline reagent instead of urea. When comparing the Examples 3A and 2B, the influence of the anion selection is apparent. An ionic co-solute selection of perchlorate influenced a lamellar micelle shape whereas an ionic co-solute selection of nitrate influenced a cubic micelle shape by the Hofmeister effect. In both examples, the FAU-type zeolite oligomers are arranged around the shaped micelles.

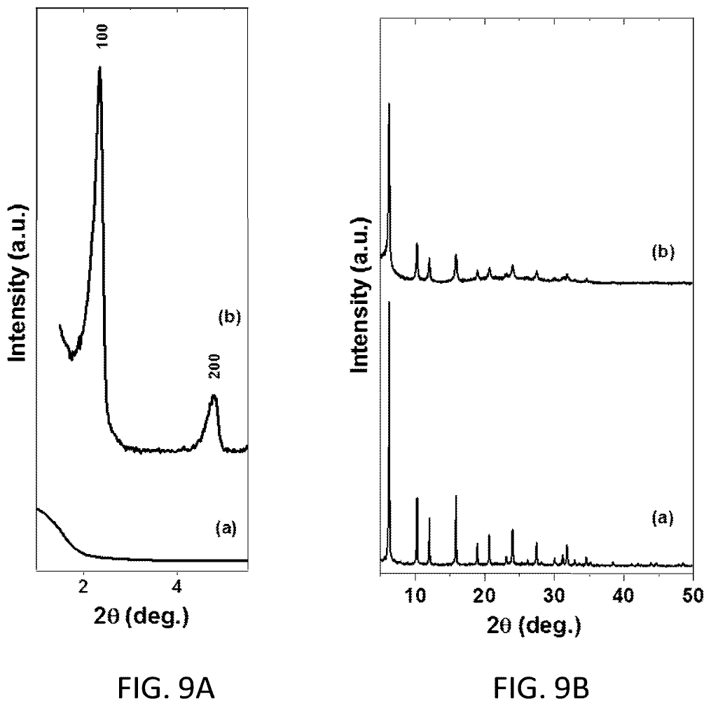

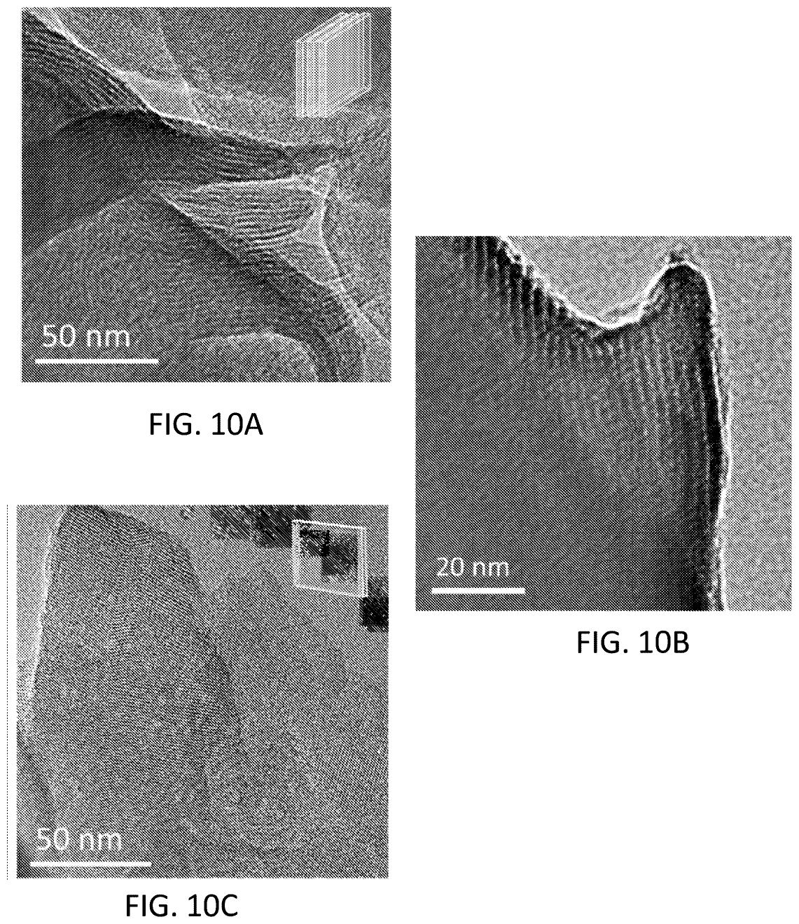

In the Example 3A, the product hierarchically ordered zeolite is a 2D-lamellar ordered mesoporous FAU-type zeolite, having lamellar mesoporous channels present in the direction with FAU micropore channels in the walls and mass of the mesostructure between mesopores. FIG. 9A depicts low-angle XRD patterns and FIG. 9B depicts high-angle XRD patterns, wherein “a” corresponds to commercial-USY (Zeolite H-Y) and “b” corresponds to Y-U-C-TMS: FIGS. 10A-C are TEM micrographs of Y-U-C-TMS showing lamellar structures, wherein: FIG. 10A shows the TEM micrograph at a scale of 50 nanometers in a planar direction [100]; FIG. 10B shows the TEM micrograph at a scale of 20 nanometers; and FIG. 10C shows the TEM micrograph at a scale of 50 nanometers in a planar direction [110]. The high-degree of long-range ordering is apparent from FIG. 9A, where low-angle XRD patterns exhibit Bragg's reflection peaks 100 and 200 indicative of 2D-lamellar (p2) mesopore symmetry. The retention of the underlying zeolite structure is apparent from FIG. 9B, where high-angle XRD patterns are consistent with those for the parent zeolite, FAU zeolite.

Table 4 shows acid properties of the parent zeolite and the synthesized Y-U-N-TMS and Y-U-S-TMS. Despite having a lower concentration of zeolitic acid sites compared with the parent zeolite, the HOCMMs synthesized are effective as catalysts supports. The Brønsted/Lewis acid site ratios are higher for the HOCMMs synthesized compared with the parent zeolite.

Example 4A: A procedure for synthesis of 3D-cubic ordered mesoporous FAU-type zeolites is provided. A quantity of 2.0 grams of urea was dissolved in 60.0 g of water to form a homogeneous solution. To this mixture, 0.2 g of ammonium nitrate (NH₄NO₃) was added as a source of ionic co-solute, and stirred to form a homogeneous solution. 2.0 g of zeolite H-Y (SAR=30) was added and stirred for 15 minutes. Subsequently, 4.0 milliliters of an organosilane, dimethyloctadecyl (3-trimethoxysilyl-propyl)-ammonium chloride (42.0 wt % in methanol), was added. The resulting solution was stirred for 2.0 hours, followed by hydrothermal treatment at 130° C. for 72 hours. The resulting solids were filtered, washed with water and dried at 120° C. for 24 hours. The synthesized product was calcined in air at 550° C. for 6 hours with a ramp rate of 60° C./hour to yield Y30-U-N-TMS (in which Y30 refers to zeolite Y formed from parent CMM having a SAR of about 30, N refers to nitrate, U refers to urea and TMS refers to dimethyloctadecyl (3-trimethoxysilyl-propyl)-ammonium chloride). Structural and textural properties of Y30-U-N-TMS are provided in Table 5.

Example 4B: A procedure for synthesis of 3D-cubic ordered mesoporous FAU-type zeolites is provided. A quantity of 2.0 grams of urea was dissolved in 60.0 g of water to form a homogeneous solution. To this mixture, 0.2 g of ammonium nitrate (NH₄NO₃) was added as a source of ionic co-solute, and stirred to form a homogeneous solution. 2.0 g of zeolite H-Y60 was added and stirred for 15 minutes. Subsequently, 4.0 milliliters of an organosilane, dimethyloctadecyl (3-trimethoxysilyl-propyl)-ammonium chloride (42.0 wt % in methanol), was added. The resulting solution was stirred for 2.0 hours, followed by hydrothermal treatment at 130° C. for 72 hours. The resulting solids were filtered, washed with water and dried at 120° C. for 24 hours. The synthesized product was calcined in air at 550° C. for 6 hours with a ramp rate of 60° C./hour to yield Y60-U-N-TMS (in which Y60 refers to zeolite Y formed from parent CMM having a SAR of about 60, N refers to nitrate, U refers to urea and TMS refers to dimethyloctadecyl (3-trimethoxysilyl-propyl)-ammonium chloride). Structural and textural properties of Y60-U-N-TMS are provided in Table 5.

Example 4C: A procedure for synthesis of 3D-cubic ordered mesoporous FAU-type zeolites that includes the addition of an alumina source material is provided. A quantity of 2.0 grams of urea was dissolved in 60.0 g of water to form a homogeneous solution. To this mixture, 0.2 g of ammonium nitrate (NH₄NO₃) was added as a source of ionic co-solute, and 0.083 g of Al(OH)₃ was added as an alumina source material and stirred to form a homogeneous solution. 2.0 g of zeolite H-Y60 was added and stirred for 15 minutes. Subsequently, 4.0 milliliters of an organosilane, dimethyloctadecyl (3-trimethoxysilyl-propyl)-ammonium chloride (42.0 wt % in methanol), was added. The resulting solution was stirred for 2.0 hours, followed by hydrothermal treatment at 130° C. for 72 hours. The resulting solids were filtered, washed with water and dried at 120° C. for 24 hours. The synthesized product was calcined in air at 550° C. for 6 hours with a ramp rate of 60° C./hour to yield Y60-U-N-Al-TMS-30 (in which Y60 refers to zeolite Y formed from parent CMM having a SAR of about 60, N refers to nitrate, Al refers to additional alumina, U refers to urea, TMS refers to dimethyloctadecyl (3-trimethoxysilyl-propyl)-ammonium chloride), and 30 refers to an approximate SAR of 30 in the final product. Structural and textural properties of Y60-U-N-Al-TMS-30 are provided in Table 5.

Example 4D: A procedure follows that of Example 4B, except that a quantity of 0.166 g of the Al(OH)₃ as the alumina source material is used to yield Y60-U-N-Al-TMS-20 (in which Y60 refers to zeolite Y formed from parent CMM having a SAR of about 60, N refers to nitrate, Al refers to additional alumina, U refers to urea, TMS refers to dimethyloctadecyl (3-trimethoxysilyl-propyl)-ammonium chloride), and 20 refers to an approximate SAR of 20 in the final product. Structural and textural properties of Y60-U-N-Al-TMS-20 are provided in Table 5.

When comparing the Examples 4A-4D, the benefit of the alumina source material contribution is apparent. The alumina source material serves to influence the SAR of the resulting material. For instance, when 0.083 g of the alumina source material was included in Ex. 4C (Y60-U-N-Al-TMS-30), the parent CMM had a SAR of 60, and the product of Ex. 4C had a SAR of about 34. Ex. 4B (Y60-U-N-TMS) which did not include the alumina source material, the parent CMM had a SAR of 60, and the product of Ex. 4B also had a SAR of about 60. Further, when 0.133 g of the alumina source material was included in Ex. 4D (Y60-U-N-A1-TMS-20), the parent CMM had a SAR of 60, and the product of Ex. 4C had a SAR of about 23.

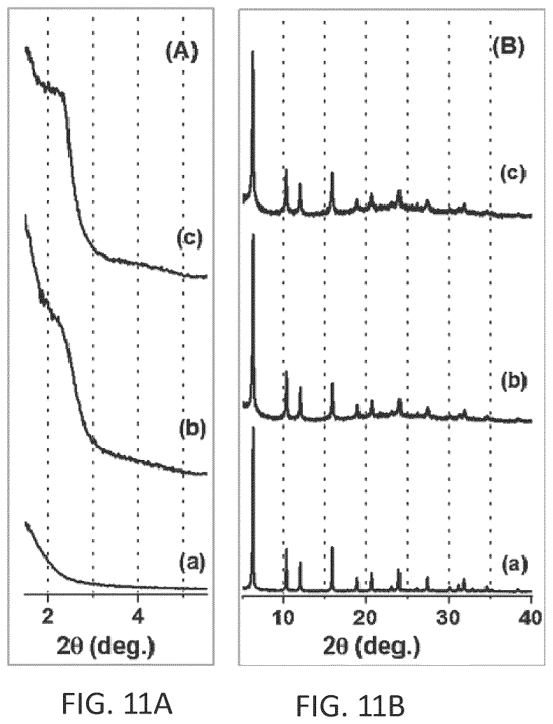

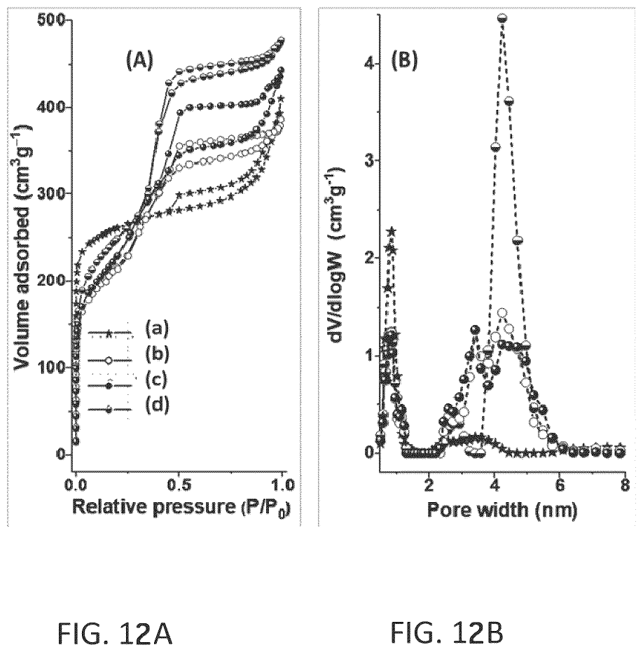

FIG. 11A depicts low-angle XRD patterns, FIG. 11B depicts high-angle XRD patterns, FIG. 12A depicts N₂ physisorption isotherms and FIG. 12B depicts DFT pore-size distributions, wherein “a” corresponds to commercial-USY (Zeolite H-Y60), “b” corresponds to Y60-U—N-Al-TMS-20 (Ex. 4D), “c” corresponds to Y60-U-N-A1-TMS-30 (Ex. 4C), and “d” corresponds to Y60-U-N-TMS (ex. 4B). As shown in FIG. 12B, inclusion of the alumina source material resulted in an increased degree of bimodal mesopore distribution in the products. As shown in Table 5, the percent contribution of mesoporous volume to total volume increased in the examples that included the alumina source material (Y60-U-N-A1-TMS-30 and Y60-U-N-A1-TMS-20) compared with Y60-U-N-TMS that did not include the alumina source materials. Unlike the parent zeolite, H-Y60 (FIG. 11A (a)), the low-angle XRD patterns of Ex. 4D (Y60-U-N-Al-TMS-20) (FIG. 11A (b)) and Ex. 4C (Y60-U-N-A1-TMS-30) (FIG. 11A (c)) show a broad peak indicating the presence of some degree of uniform mesoporosity. The low-angle XRD peak of Y60-U-N-Al-TMS-30 is relatively more uniform due to the lesser influence from the external aluminum. On the other hand, high-angle XRD patterns show characteristic FAU-type reflections suggesting the parent crystallinity has been retained in the modified hierarchical zeolites with distinct aluminum distribution.

According to the examples herein, hierarchically ordered FAU-type frameworks exhibiting 2D-hexagonal (p6 mm), 3D-cubic (Ia-3d) and 2D-lamellar (p2) mesopore symmetries are prepared by a methodical post-synthetic reassembly.

As used herein, the phrase “a major portion” with respect to a particular composition and/or solution and/or other parameter means at least about 50% and up to 100% of a unit or quantity. As used herein, the phrase “a significant portion” with respect to a particular composition and/or solution and/or other parameter means at least about 75% and up to 100% of a unit or quantity. As used herein, the phrase “a substantial portion” with respect to a particular composition and/or solution and/or other parameter means at least about 90, 95, 98 or 99% and up to 100% of a unit or quantity. As used herein, the phrase “a minor portion” with respect to a particular composition and/or solution and/or other parameter means at least about 1, 2, 4 or 10%, up to about 20, 30, 40 or 50% of a unit or quantity.

A first aspect of the present disclosure is directed to a method of making a hierarchically ordered crystalline microporous material, the method comprising: forming an aqueous suspension comprising: a parent crystalline microporous material; an alkaline reagent; a supramolecular template; and a silica source material, an alumina source material, or both; hydrothermally treating the aqueous suspension to form the hierarchically ordered crystalline microporous material, wherein: the hierarchically ordered crystalline microporous material has a greater degree of mesoporosity than the parent crystalline microporous material; and the hierarchically ordered crystalline microporous material has a silica-to-alumina ratio (SAR) that is at least 0.5 different than the parent crystalline microporous material.

A second aspect may include the first aspect, wherein the aqueous suspension comprises the alumina source material, and the alumina source material is chosen from aluminates, alumina, aluminum colloids, boehmites, pseudo-boehmites, aluminum hydroxides, aluminum salts, aluminum alkoxides, aluminum wire, alumina gels, zeolites, or combinations thereof.

A second aspect may include the first aspect, wherein the aqueous suspension comprises the alumina source material, and the alumina source material is chosen from aluminates, alumina, aluminum colloids, boehmites, pseudo-boehmites, aluminum hydroxides, aluminum salts, aluminum alkoxides, aluminum wire, alumina gels, zeolites, or combinations thereof.

A third aspect may include any preceding aspect, wherein the aqueous suspension comprises the silica source material, and the silica source material is chosen from sodium silicate, fumed silica, precipitated silica, colloidal silica, silica gels, zeolites, dealuminated zeolites, rice husk, silicon hydroxides, silicon alkoxides, or combinations thereof.

A fourth aspect may include any preceding aspect, wherein the aqueous suspension has a weight ratio of the parent crystalline microporous material to the silica source material, the alumina source material, or both of from 100:1 to 1:1.

A fifth aspect may include any preceding aspect, wherein the hierarchically ordered crystalline microporous material has a bimodal mesopore size distribution comprising a first peak and a second peak.

A sixth aspect may include any preceding aspect, wherein the first peak is from 2 nm to 4 nm and the second peak is from 4 nm to 6 nm.

A seventh aspect may include any preceding aspect, wherein the aqueous suspension further comprises an ionic co-solute that is separate from an anion associated with the supramolecular template.

An eighth aspect may include any preceding aspect, wherein the ionic co-solute is chosen from CO₃²⁻, SO₄²⁻, S₂O₃²⁻, H₂PO₄⁻, F⁻, Cl⁻, Br⁻, NO₃⁻, I⁻, ClO₄⁻, SCN⁻ and C₆H₅O₈³⁻.

A ninth aspect may include any preceding aspect, wherein the supramolecular template is a surfactant having one or more dimensions larger than dimensions of micropores of the parent crystalline microporous material.

A tenth aspect may include any the ninth aspect, wherein the supramolecular template comprises least one moiety as a head group or a tail group, chosen from organosilanes, hydroxysilyls, alkoxysilyls, aromatics, branched alkyls, sulfonates, carboxylates, phosphates, and combinations thereof.

An eleventh aspect may include any preceding aspect, wherein the supramolecular template comprises at least one cationic moiety chosen from a quaternary ammonium moiety and a phosphonium moiety.

A twelfth aspect may include any preceding aspect, wherein the supramolecular template comprises at least one quaternary ammonium group having a terminal alkyl group with 6-24 carbon atoms.

A thirteenth aspect may include any preceding aspect, wherein the supramolecular template comprises two quaternary ammonium groups wherein an alkyl group bridging the quaternary ammonium groups comprises 1-10 carbon atoms.

A fourteenth aspect may include any preceding aspect, wherein the supramolecular template comprises at least one quaternary ammonium group, and at least one head group moiety chosen from organosilanes, hydroxysilyls, alkoxysilyls, aromatics, branched alkyls, sulfonates, carboxylates, phosphates and combinations comprising one of the foregoing moieties.

A fifteenth aspect may include any preceding aspect, wherein the supramolecular template comprises dimethyloctadecyl (3-trimethoxysilyl-propyl)-ammonium or a derivative of dimethyloctadecyl (3-trimethoxysilyl-propyl)-ammonium.

A sixteenth aspect may include any preceding aspect, wherein the alkaline reagent is provided at a concentration in the aqueous suspension of about 0.1 wt. % to 5 wt. % and is chosen from ammonia, ammonium hydroxide and urea.

A seventeenth aspect may include any preceding aspect, further comprising calcining the hierarchically ordered mesostructures.

An eighteenth aspect may include any preceding aspect, wherein the parent crystalline microporous material comprises a zeolite or zeolite-type material.

A nineteenth aspect may include any preceding aspect, wherein the parent crystalline microporous material is a zeolite having a framework chosen from AEI, *BEA, CHA, FAU, MFI, MOR, LTL, LTA and MWW.

A twentieth aspect may include any preceding aspect, wherein the hydrothermally treating of the aqueous suspension is under conditions effective to form oligomeric units of the parent crystalline microporous material, form shaped micelles of the supramolecular template, and induce assembly of the oligomeric units around the shaped micelles.

It will be apparent to persons of ordinary skill in the art that various modifications and variations can be made without departing from the scope disclosed herein. Since modifications, combinations, sub-combinations, and variations of the disclosed embodiments, which incorporate the spirit and substance disclosed herein, may occur to persons of ordinary skill in the art, the scope disclosed herein should be construed to include everything within the scope of the appended claims and their equivalents.

For the purposes of defining the present technology, the transitional phrase “consisting of” may be introduced in the claims as a closed preamble term limiting the scope of the claims to the recited components or steps and any naturally occurring impurities. For the purposes of defining the present technology, the transitional phrase “consisting essentially of” or “consists essentially of” may be introduced in the claims to limit the scope of one or more claims to the recited elements, components, materials, or method steps as well as any non-recited elements, components, materials, or method steps that do not materially affect the novel characteristics of the claimed subject matter. The transitional phrases “consisting of” and “consisting essentially of” may be interpreted to be subsets of the open-ended transitional phrases, such as “comprising” and “including,” such that any use of an open ended phrase to introduce a recitation of a series of elements, components, materials, or steps should be interpreted to also disclose recitation of the series of elements, components, materials, or steps using the closed terms “consisting of” and “consisting essentially of.” For example, the recitation of a composition “comprising” components A, B, and C should be interpreted as also disclosing a composition “consisting of” components A, B, and C as well as a composition “consisting essentially of” components A, B, and C. Any quantitative value expressed in the present application may be considered to include open-ended embodiments consistent with the transitional phrases “comprising” or “including” as well as closed or partially closed embodiments consistent with the transitional phrases “consisting of” and “consisting essentially of.”

As used in the Specification and appended Claims, the singular forms “a”, “an”, and “the” include plural references unless the context clearly indicates otherwise. The verb “comprises” and its conjugated forms should be interpreted as referring to elements, components or steps in a non-exclusive manner. The referenced elements, components or steps may be present, utilized or combined with other elements, components or steps not expressly referenced.

It should be understood that any two quantitative values assigned to a property may constitute a range of that property, and all combinations of ranges formed from all stated quantitative values of a given property are contemplated in this disclosure. The subject matter disclosed herein has been described in detail and by reference to specific embodiments. It should be understood that any detailed description of a component or feature of an embodiment does not necessarily imply that the component or feature is essential to the particular embodiment or to any other embodiment. Further, it should be apparent to those skilled in the art that various modifications and variations can be made to the described embodiments without departing from the spirit and scope of the claimed subject matter.

TABLE 1
Crystal systems.

| System | Unit cell | Essential symmetry of crystal |
|---|---|---|
| Triclinic | No special relationship | None |
| Monoclinic | a ≠ b ≠ c | Two-fold axis or mirror plane |
| | α = γ = 90° ≠ β | (inverse two-fold axis) |
| Orthorhombic | a ≠ b ≠ c | Three orthogonal two-fold or |
| | α = β = γ = 90° | inverse two-fold axes |
| Tetragonal | a = b ≠ c | One four-fold or inverse four- |
| | α = β = γ = 90° | fold axis |
| Trigonal | a = b = c | One three-fold axis or inverse |
| | α = β = γ ≠ 90° | three-fold axis |
| Hexagonal | a = b ≠ c | One six-fold or inverse six-fold |
| | α = β = 90°, γ = 120° | axis |
| Cubic | a = b = c | Four three-fold axes |
| | α = β = γ = 90° | |

TABLE 2
Crystal classes

Crystal classes (point group)

| | Non- | |
|---|---|---|
| System | centrosymmetric | Centrosymmetric |
| Triclinic | 1 | 1̅ |
| Monoclinic | 2, m (=2̅) | 2/m |
| Orthorhombic | 222, 2mm | mmm |
| Tetragonal | 4, 4̅ | 4/m |
| | 422, 4mm, 4̅2m | 4/mmm |
| Trigonal | 3 | 3̅ |
| | 32, 3m | 3̅m |
| Hexagonal | 6, 6̅ | 6/m |
| | 622, 6mm, 6̅2m | 6/mmm |
| Cubic | 23 | m3̅ |
| | 432, 4̅3m | m3̅m |

TABLE 3
Structural and textural properties of hierarchical zeolites

| | αₒª | | | | | | | |
|---|---|---|---|---|---|---|---|---|
| | Micro | Meso | Si/ | S_{BET} (m² g⁻¹) ^{c} | | D | Vₚ (cm³ g⁻¹)^{e} | |
| Sample | (Å)^{§} | [symbol] | Al ^{b} | Micro | Total | (nm) ^{d} | Micro | Total |
| Y-U-N-TMS | 24.36 | 10.1^{¢} | 11.1 | 436 | 853 | 4.2 | 0.18 | 0.51 |
| Y-U-S-TMS | 24.40 | 5.2^{¥} | 11.3 | 394 | 834 | 4.4 | 0.16 | 0.48 |
| Y-U-C-TMS | 24.22 | 4.1^{£} | 14.6 | 533 | 765 | — | 0.21 | 0.32 |
| HY-30 | 24.28 | — | 14.8 | 561 | 820 | — | 0.27 | 0.31 |
| Y-U-TMS | 24.21 | — | 13.9 | 417 | 804 | — | 0.16 | 0.39 |
| Y-AH-TMS | 24.34 | 5.1^{¥} | 10.4 | 210 | 703 | 4.7 | 0.10 | 0.61 |
| Y-AH-CT | 24.37 | — | 12.2 | 281 | 619 | — | 0.12 | 0.44 |

^{a}unit-cell parameter;
^{b} from ²⁹Si magic angle spinning-NMR;
^{c} Brunauer-Emmett-Teller (BET) surface area;
^{d} mesopore size;
^{e}pore volume;
^{§}calculated from calcined high-angle x-ray diffraction (XRD) patterns; [symbol]
calculated from calcined low-angle (LA) XRD patterns using formula-
^{¥}a = 2d · (h² + hk + k²/3);
^{¢}a = d (h² + k² +z²).
^{£}calculated from as-synthesized LA-XRD pattern.

TABLE 4
Acid properties and catalytic activities*

| Zeolite | BAS^{§} | LAS^{¥} | Total | BI [symbol] |
|---|---|---|---|---|
| Y-U-S-TMS | 146.9 | 104.1 | 251.0 | 1.4 |
| Y-U-N-TMS | 127.6 | 77.1 | 204.7 | 1.7 |
| HY-30 | 275.6 | 443.1 | 718.7 | 0.6 |

*from pyridine FT-IR recorded at 150° C.;
^{§}Brønsted acid sites;
^{¥}Lewis acid sites; [symbol]
Brønsted/Lewis acid ratio.

TABLE 5
Structural and textural properties of hierarchical zeolites

| | | S_{BET} | | | Vₚ (cm³ | | Mesopore |
|---|---|---|---|---|---|---|---|
| | Si/ | (m² g⁻¹) ^{c} | | D | g⁻¹)^{e} | | volume |
| Sample | Al ^{(ICP)} | Micro^{T} | Total | (nm) ^{d} | Micro^{T} | Total | (%)^{T} |
| Y30-U-N- | 21.8 | 374 | 964 | 4.3 | 0.15 | 0.75 | 80.0 |
| TMS | | | | | | | |
| Y60-U-N- | 60.4 | 291 | 897 | 4.2 | 0.12 | 0.72 | 83.3 |
| TMS | | | | | | | |
| Y60-U-N- | 34.5 | 190 | 772 | 3.7, | 0.08 | 0.57 | 85.9 |
| Al-TMS-30 | | | | 4.2 | | | |
| (Ex. 4C) | | | | | | | |
| Y60-U-N- | 23.0 | 185 | 813 | 3.7, | 0.08 | 0.65 | 87.6 |
| Al-TMS-20 | | | | 4.4 | | | |
| (Ex. 4D) | | | | | | | |
| HY-60 | 60.0 | 738 | 1000 | — | 0.29 | 0.58 | 50.0 |

^{c} Brunauer-Emmett-Teller (BET) surface area;
^{d} mesopore size;
^{e}pore volume;
^{(ICP)} Inductively coupled plasma analysis;
^{T}from t-plot.

What is claimed is:

1. A method of making a hierarchically ordered crystalline microporous material, the method comprising:
forming an aqueous suspension comprising:
a parent crystalline microporous material;
an alkaline reagent;
a supramolecular template; and
a silica source material, an alumina source material, or both;
hydrothermally treating the aqueous suspension to form the hierarchically ordered crystalline microporous material, wherein:
the hierarchically ordered crystalline microporous material has a greater degree of mesoporosity than the parent crystalline microporous material; and
the hierarchically ordered crystalline microporous material has a silica-to-alumina ratio (SAR) that is at least 0.5 different than the parent crystalline microporous material.

2. The method of claim 1, wherein the aqueous suspension comprises the alumina source material, and the alumina source material is chosen from aluminates, alumina, aluminum colloids, boehmites, pseudo-boehmites, aluminum hydroxides, aluminum salts, aluminum alkoxides, aluminum wire, alumina gels, zeolites, or combinations thereof.

3. The method of claim 1, wherein the aqueous suspension comprises the silica source material, and the silica source material is chosen from sodium silicate, fumed silica, precipitated silica, colloidal silica, silica gels, zeolites, dealuminated zeolites, rice husk, silicon hydroxides, silicon alkoxides, or combinations thereof.

4. The method of claim 1, wherein the aqueous suspension has a weight ratio of the parent crystalline microporous material to the silica source material, the alumina source material, or both of from 100:1 to 1:1.

5. The method of claim 1, wherein the hierarchically ordered crystalline microporous material has a bimodal mesopore size distribution comprising a first peak and a second peak.

6. The method of claim 5, wherein the first peak is from 2 nm to 4 nm and the second peak is from 4 nm to 6 nm.

7. The method of claim 1, wherein the aqueous suspension further comprises an ionic co-solute that is separate from an anion associated with the supramolecular template.

8. The method of claim 7, wherein the ionic co-solute is chosen from CO₃²⁻, SO₄²⁻, S₂O₃²⁻, H₂PO₄⁻, F⁻, Cl⁻, Br⁻, NO₃⁻, I⁻, ClO₄⁻, SCN⁻ and C₆H₅O₈³⁻.

9. The method of claim 1, wherein the supramolecular template is a surfactant having one or more dimensions larger than dimensions of micropores of the parent crystalline microporous material.

10. The method of claim 9, wherein the supramolecular template comprises least one moiety as a head group or a tail group, chosen from organosilanes, hydroxysilyls, alkoxysilyls, aromatics, branched alkyls, sulfonates, carboxylates, phosphates, and combinations thereof.

11. The method of claim 1, wherein the supramolecular template comprises at least one cationic moiety chosen from a quaternary ammonium moiety and a phosphonium moiety.

12. The method of claim 1, wherein the supramolecular template comprises at least one quaternary ammonium group having a terminal alkyl group with 6-24 carbon atoms.

13. The method of claim 1, wherein the supramolecular template comprises two quaternary ammonium groups wherein an alkyl group bridging the quaternary ammonium groups comprises 1-10 carbon atoms.

14. The method of claim 1, wherein the supramolecular template comprises at least one quaternary ammonium group, and at least one head group moiety chosen from organosilanes, hydroxysilyls, alkoxysilyls, aromatics, branched alkyls, sulfonates, carboxylates, phosphates and combinations comprising one of the foregoing moieties.

15. The method of claim 1, wherein the supramolecular template comprises dimethyloctadecyl (3-trimethoxysilyl-propyl)-ammonium or a derivative of dimethyloctadecyl (3-trimethoxysilyl-propyl)-ammonium.

16. The method of claim 1, wherein the alkaline reagent is provided at a concentration in the aqueous suspension of about 0.1 wt. % to 5 wt. % and is chosen from ammonia, ammonium hydroxide and urea.

17. The method of claim 1, further comprising calcining the hierarchically ordered mesostructures.

18. The method of claim 1, wherein the parent crystalline microporous material comprises a zeolite or zeolite-type material.

19. The method of claim 1, wherein the parent crystalline microporous material is a zeolite having a framework chosen from AEI, *BEA, CHA, FAU, MFI, MOR, LTL, LTA and MWW.

20. The method of claim 1, wherein the hydrothermally treating of the aqueous suspension is under conditions effective to form oligomeric units of the parent crystalline microporous material, form shaped micelles of the supramolecular template, and induce assembly of the oligomeric units around the shaped micelles.
